(19) United States
(12) Patent Application Publication
(10) Pub. No.: US 2017/0179773 A1
(43) Pub. Date: Jun. 22, 2017

(54) COIL FOR WIRELESS COMMUNICATIONS, COIL MODULE AND MOBILE TERMINAL USING THE SAME

(71) Applicant: SAMSUNG ELECTRO-MECHANICS CO., LTD., Suwon-si (KR)

(72) Inventors: Hee Seung KIM, Suwon-si (KR); Ki Won CHANG, Suwon-si (KR); Jae Sun WON, Suwon-si (KR)

(73) Assignee: SAMSUNG ELECTRO-MECHANICS CO., LTD., Suwon-si (KR)

(21) Appl. No.: 15/379,069

(22) Filed: Dec. 14, 2016

(30) Foreign Application Priority Data
Dec. 17, 2015 (KR) 10-2015-0181284
Feb. 4, 2016 (KR) 10-2016-0013922
May 26, 2016 (KR) 10-2016-0065046

(51) Int. Cl. H02J 50/80; H01F 38/14; H04B 5/00; H02J 7/02

(52) U.S. Cl. CPC H02J 50/80; H02J 7/025; H01F 38/14; H04B 5/0081

(57) ABSTRACT

A composite wireless transmitter coil includes a first coil; and a second coil spaced apart from the first coil, wherein the first coil and the second coil form a first magnetic field, and a magnetic line of force of the first magnetic field has a closed loop shape that passes through a region of the first coil and a region of the second coil.

### CROSS-REFERENCE TO RELATED APPLICATION

This application claims the benefit of Korean Patent Application Nos. 10-2015-0181284 filed on Dec. 17, 2015, 10-2016-0013922 filed on Feb. 4, 2016 and 10-2016-0065046 filed on May 26, 2016 in the Korean Intellectual Property Office, the entire disclosures of which are incorporated herein by reference for all purposes.

### BACKGROUND

1. Field

The following description relates to a coil for wireless communications and a mobile terminal using the same.

2. Description of Related Art

Wireless communications using a coil are applied to various applications. In particular, wireless communications technology using such a coil is applied in connection with electronic approval of certain transactions.

In wireless communications technology, a receiving coil is magnetically coupled to a magnetic field formed by a transmitting coil in such a manner that data is transmitted therebetween. Accordingly, reliability of the data transmission is able to be determined depending on a degree of magnetic coupling between the transmitting coil and the receiving coil.

Wireless communications technology implementing the coil may be applied to various applications, and angles or positions of the transmitting coil and the receiving coil may be changed depending on the applications. As a result of potential mismatch, misalignment, or distance, or other such factors, reliability of data transmission is not ideal and is often substantially degraded.

As such, in order to simultaneously satisfy the operating requirements of various applications, it may be necessary to mount a plurality of coils in a single mobile terminal. Meanwhile, there is demand for miniaturization and slimness of the mobile terminals, even while such a plurality of coils are applied thereto.

Therefore, there is demand for a coil module having improved communications performance while also allowing for the efficient mounting of various types of coils in a predetermined space, and a wireless power receiver using the same.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to a general aspect, a composite wireless transmitter coil, includes a first coil; and a second coil spaced apart from the first coil, wherein the first coil and the second coil form a first magnetic field, and a magnetic line of force of the first magnetic field has a closed loop shape that passes through a region of the first coil and a region of the second coil.

The composite coil may further include a metal part formed to be spaced apart from the first coil and the second coil between the first coil and the second coil, on a plane which is substantially the same as or is substantially parallel to the first coil or the second coil.

The composite coil may further include a metal part overlapping the region of the first coil or the region of the second coil, on a plane which is substantially the same as or is substantially parallel to the first coil or the second coil.

The metal part may include a metal plate comprising a slit or a through hole, and the slit or the through hole overlaps the region of the first coil or the region of the second coil.

The first coil may form a second magnetic field, the second coil may form a third magnetic field, and the first magnetic field may be formed by interacting the second magnetic field and the third magnetic field with each other.

The first coil and the second coil may be disposed on a plane which is substantially the same or substantially parallel to each other, and the second magnetic field and the third magnetic field may be reinforced by each other in a first direction directed from the first coil to the second coil, or a second direction directed from the second coil to the first coil.

The first coil may be wound in a clockwise direction, the second coil may be wound in a counterclockwise direction, and the first coil and the second coil may be configured to have a current flowing in the first coil and a current flowing in the second coil flowing in the clockwise direction.

The first coil and the second coil may be wound in a clockwise direction, the first coil may be configured to have a current flowing in the clockwise direction, and the second coil may be configured to have a current flowing in a counterclockwise direction.

The first coil may be a solenoid coil wound around a first magnetic body about a first axis direction, and the second coil may be a solenoid coil wound around a second magnetic body about a second axis direction which is substantially the same as or substantially parallel to the first axis direction.

According to another general aspect, a mobile terminal includes a housing; a first coil disposed proximate to a first portion of the housing; and a second coil spaced apart from the first coil in a length direction of the housing and disposed proximate to a second portion of the housing.

The first coil and the second coil may form a first magnetic field, and a magnetic line of force representing the first magnetic field has a closed loop shape that passes through the first region of the first coil and the first region of the second coil.

The housing may further include a non-metal part wherein at least some regions of the first coil and at least some regions of the second coil overlap the non-metal part, and, a metal part overlapping a second region of the first coil different from the first region or a second region of the second coil different from the first region, on a plane which is substantially the same as or substantially parallel to the first coil or the second coil.

The metal part may include a slit or a through hole, and a shape of the non-metal part corresponds to a shape of the slit or the through hole.

The first coil may be wound in a clockwise direction, the second coil may be wound in a counterclockwise direction, and the first and second coils are configured to have a current flowing in the first coil and a current flowing in the second coil flowing in the clockwise direction.

The first coil and the second coil may be wound in a clockwise direction, the first coil may be configured to have a current flowing in the clockwise direction, and the second coil may be configured to have a current flowing in a counterclockwise direction.

The first coil may be a solenoid coil wound around a first magnetic body about a first axis direction, and the second coil may be a solenoid coil wound around a second magnetic body about a second axis direction which may be substantially the same as or substantially parallel to the first axis direction.

The first and second coils may be affixed to the housing.

According to another general aspect, a mobile terminal includes a longitudinally disposed housing; a composite coil including a first coil portion and a second coil portion displaced from the first coil portion, the first and second coil portions being disposed on the housing, wherein the first coil portion and the second coil portion are configured to generate complementary magnetic fields.

The first coil portion and the second coil portion may be respectively disposed at opposing ends of the housing.

The first coil portion may be coupled to the second coil portion.

The first coil portion and the second coil portion may be configured to collectively generate a longitudinally extending magnetic field having a magnetic force line passing from the first coil portion to the second coil portion and substantially spanning a length of the housing.

The mobile terminal may further include a magnetic sheet disposed to cover a face of the first and second coil portions.

The first coil portion and the second coil portion may be configured to respectively generate the complementary magnetic fields opposingly extending along an axis transverse to a plane defined by the housing.

The first and the second coil portions may further include a magnetic body, wherein the first and second coil portions may be wound around the magnetic body and be collectively configured to generate the complementary magnetic fields extending along an axis substantially parallel with the housing.

The housing may include a metallic plate disposed between the first and second coil portions, the metallic plate may extend substantially between opposing longitudinal ends of the housing.

First and second magnetic field passages may be defined through the metallic plate, the first and second magnetic field passages may be respectively disposed in registration with the first and second coil portions and configured to permit passage of magnetic flux therethrough to define a longitudinally extending magnetic field along the housing.

The mobile terminal may further include third and fourth coil portions, the third and fourth coil portions may be configured to generate complementary magnetic fields extending in a direction transverse to the magnetic fields of the first and second coil portions.

According to another general aspect, a mobile terminal, includes a first conductive coil portion; a second conductive coil portion displaced along a housing from the first conductive coil portion, wherein the first and second conductive coil portions are configured to generate magnetic fields which are mutually reinforcing; and, a processor coupled to the first and second conductive coil portions, the processor configured to collectively modulate magnetic fields according to an account number.

The mobile terminal may further include a memory coupled to the processor, the memory may be configured to retrievably store the account number; and, the processor may be further configured to collectively modulate the magnetic fields according to the account number stored in the memory.

According to an aspect of the present disclosure, a coil module may include a substrate; a coil for wireless communications formed on one region of the substrate, performing communications with a first device wirelessly, using a first magnetic field; and a coil for wireless charging formed on the other region of the substrate, receiving power from a second device wirelessly, wherein the coil for wireless communications is wound around a first axis, and the coil for wireless charging is wound around a second axis, disposed perpendicular to the first axis.

The first axis may be a direction parallel to the substrate, and the second axis may be a direction perpendicular to the substrate.

The substrate may include a first magnetic body in one region of the substrate, and the coil for wireless communications is a solenoid coil wound around the first magnetic body.

The coil for wireless charging may be formed on one surface of the other region of the substrate, and a second magnetic body may be formed on the other surface of the other region of the substrate.

The first magnetic body may be formed of a material different than that of the second magnetic body.

The coil for wireless communications may include a first coil formed on one side of the coil for wireless charging, a second coil formed on the other side of the coil for wireless charging, the first coil and the second coil form the first magnetic field, and a magnetic line of force of the first magnetic field has a closed loop shape that passes through a region of the first coil and a region of the second coil.

The first coil and the second coil may be solenoid coils wound in the same direction as each other, and a direction of a current flowing in the first coil and a direction of a current flowing in the second coil are the same as each other.

The first coil and the second coil may be solenoid coils wound in directions opposing each other, and a direction of a current flowing in the first coil and a direction of a current flowing in the second coil are the same as each other.

The coil for wireless communications may include a first communications coil pattern formed on one surface of the substrate, a second communications coil pattern formed on the other surface of the substrate, a plurality of via holes connected to the first communications coil pattern and the second communications coil pattern, and the substrate includes a first magnetic body included in an inner region formed by the first communications coil pattern, the second communications coil pattern, and the plurality of via holes.

According to another aspect of the present disclosure, a mobile terminal receiving power wirelessly, or transmitting or receiving communications data wirelessly, using a coil module, may include a coil module including a substrate, a coil for wireless communications, and a coil for wireless charging formed on the substrate; a wireless communications unit performing communications with a first device wirelessly, through the coil for wireless communications; and a wireless charging unit, receiving power from a second device wirelessly through the coil for wireless charging, wherein the coil for wireless communications is wound around a first axis, and the coil for wireless charging is wound around a second axis, disposed perpendicular to the first axis.

The first axis may be a direction parallel to the substrate, and the second axis may be a direction perpendicular to the substrate.

The substrate may include a first magnetic body in one region of the substrate, and the coil for wireless communications may be a solenoid coil wound around the first magnetic body.

The coil for wireless charging may be formed on one surface of the other region of the substrate, and a second magnetic body may be formed on the other surface of the other region of the substrate.

The first magnetic body may be formed of a material different than that of the second magnetic body.

The coil for wireless communications may includes a first communications coil formed on one side of the coil for wireless charging, and a second communications coil formed on the other side of the coil for wireless charging, and the first communications coil and the second communications coil form a first magnetic field, and a magnetic line of force of the first magnetic field has a closed loop shape that passes through a region of the first communications coil and a region of the second communications coil.

The coil for wireless communications may includes a first communications coil pattern formed on one surface of the substrate, a second communications coil pattern formed on the other surface of the substrate and a plurality of via holes connected to the first communications coil pattern and the second communications coil pattern, and the substrate includes a first magnetic body included in an inner region formed by the first communications coil pattern, the second communications coil pattern, and the plurality of via holes.

Further, in this Summary, all features of the present disclosure are not mentioned. Various means for solving an object of the present disclosure may be understood in more detail with reference to specific exemplary embodiments provided in the following detailed description.

Other features and aspects will be apparent from the following detailed description, the drawings, and the claims.

### BRIEF DESCRIPTION OF DRAWINGS

FIG. 1 is a perspective view illustrating a mobile terminal using a coil for wireless communications according to an embodiment which performs wireless communications.

FIG. 2 is a block diagram illustrating a magnetic card reader according to an embodiment.

FIG. 3 is a perspective view illustrating an embodiment of a magnetic head illustrated in FIG. 2.

FIG. 4 is a view illustrating a voltage across the magnetic head adjacent to a magnetic card according to an embodiment.

FIG. 5 is a view illustrating an example in which the magnetic head of the magnetic card reader is magnetically coupled to a transmitting coil comprising one coil.

FIG. 6 is a cross-sectional view illustrating various positions of the magnetic head which is magnetically coupled to a transmitting coil comprising one coil.

FIG. 7 is a graph illustrating areas where signal is too attenuated to permit communications (disabled or null areas) depending on a distance from a central portion of the coil, in the transmitting coil illustrated in FIG. 6.

FIG. 8 is a perspective view illustrating a coil for wireless communications according to an embodiment.

FIG. 9 is a cross-sectional view illustrating an example cross section of the coil for wireless communications illustrated in FIG. 8.

FIG. 10 is a cross-sectional view illustrating another example of the coil for wireless communications.

FIG. 11 is a graph illustrating coupling coefficients of the magnetic head in an example in which one coil is used as the transmitting coil, and another example in which a plurality of coils are used as the transmitting coil.

FIG. 12 is a view illustrating an example of a coil for wireless communications.

FIG. 13 is a view illustrating another example of a coil for wireless communications.

FIG. 14 is a view illustrating another example of a coil for wireless communications.

FIG. 15 is a view illustrating another example of a coil for wireless communications.

FIG. 16 is a view illustrating a coil for wireless communications including a coil wound in a ‘π’ shape, according to an embodiment.

FIG. 17 is a view illustrating a coil for wireless communications wound in an asymmetrical shape, according to an embodiment.

FIG. 18 is a view illustrating a coil for wireless communications including a coil wound in a ‘r” shape, according to an embodiment.

FIG. 19 is a view illustrating a coil for wireless communications including three or more coil portions according to an embodiment.

FIG. 20 is a view illustrating an example of a coil for wireless communications using a solenoid.

FIG. 21 is a view illustrating another example of a coil for wireless communications using a solenoid.

FIGS. 22A through 22H are reference views illustrating various layouts of solenoid coils according to one or more embodiments.

FIG. 23 is a view illustrating an example of a mobile terminal.

FIG. 24 is a view illustrating another example of a mobile terminal.

FIG. 25 is a view illustrating another example of a mobile terminal.

FIG. 26 is a view illustrating another example of a mobile terminal, which illustrates an example of a metal part including a through hole.

FIG. 27 is a view illustrating another example of a mobile terminal, which illustrates an example of a metal part including a slit.

FIG. 28 is a view illustrating another mobile terminal according to an embodiment, which illustrates an example of a metal part including a plurality of metal plates.

FIG. 29 is a perspective view illustrating an example of a mobile terminal to which a coil module according to an embodiment is applied.

FIG. 30 is a perspective view illustrating an example of a mobile terminal to which a coil module according to an embodiment is applied.

FIG. 31 is a block diagram illustrating a mobile terminal according to an embodiment.

FIG. 32 is a perspective view illustrating an example of a coil module according to an embodiment.

FIG. 33 is an exploded perspective view illustrating an example of a coil module formed using a multilayer substrate.

FIG. 34 is a cross-sectional view of the coil module illustrated in FIG. 33 taken along line I-I.

FIG. 35 is a perspective view illustrating another example of a coil module according to an embodiment.

FIG. 36 is an exploded perspective view illustrating another example of a coil module formed using a multilayer substrate.

FIG. 37 is a cross-sectional view of the coil module illustrated in FIG. 36 taken along line I′-I′.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, it will be understood that when an element, a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there are no elements or layers intervening therebetween. Like numerals refer to like elements throughout. As used herein, the term “or” or “and/or” includes any and all combinations of one or more of the associated listed items. For example, where e.g. “at least one of x or y” is recited, there may be x, there may be y, and/or there may x and y.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” relative to other elements would then be oriented “below,” or “lower” than the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, is not intended to be limiting. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

In the drawings, due to manufacturing techniques and/or tolerances, for example, modifications of the shape shown may be encountered. Thus, embodiments should not be construed as being limited to the particular shapes of regions shown herein, but should be understood to include, for example changes in shape resulting from manufacturing. The following embodiments may also be constituted by one or a combination thereof.

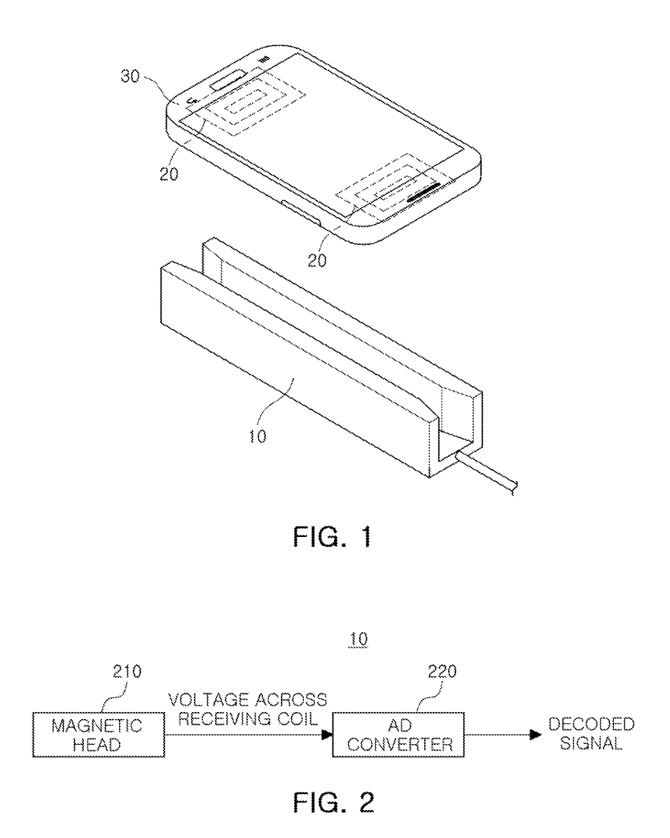

FIG. 1 is a perspective view illustrating an example in which a mobile terminal using a coil for wireless communications performs the wireless communications.

A composite coil 20 for wireless communications is applied to a mobile terminal 30. The coil 20 for wireless communications forms a magnetic field under control of the mobile terminal 30.

The composite coil 20 for wireless communications is operated as a transmitting coil, by actuation of a processor for collective modulation of the constituent coil portions of the composite coil 20 with a pattern corresponding to an account number stored in a memory. The coil 20 is thereby magnetically coupled to a wireless signal receiver including a receiving coil to wirelessly transmit information.

Acting as the wireless signal receiver including the receiving coil, a magnetic card reader 10 is illustrated in FIG. 1. According to embodiments, the wireless signal receiver includes the receiving coil. Various wireless signal receivers may be used in addition to the magnetic card reader 10.

The coil 20 for wireless communications, according to one or more embodiments, includes a plurality of coils. The plurality of coils individually, or collectively, form the magnetic field. In other words, the plurality of coils included in the coil 20 for wireless communications form a widespread magnetic field and increase performance of a magnetic coupling even if a position or an angle of the receiving coil of the magnetic card reader 10 is changed.

In the illustrated example, the coil 20 for wireless communications forms the magnetic field that passes through a center between two coils and is formed to be elongated in a length, or longitudinal, direction of the mobile terminal 30. As a result, the coil 20 for wireless communications has a wide range of suitable magnetic coupling positions with the magnetic card reader 10.

A processor modulates the composite coil 20 for wireless communications to transmit data—for example, card number data, authentication information, transaction identification, subscriber information, account numbers, financial or service provider account information, mobile terminal information, error corrective codes, checksums—intended to be transmitted to the magnetic card reader 10 by changing or modulating a direction, intensity, or other suitable operational characteristic of the magnetic field. In other words, the magnetic card reader 10 reads the card number data using a change in a voltage across the receiving coil caused by changes in the magnetic field, such as, for example, changing the direction of the magnetic field formed by the coil 20 for wireless communications. Other suitable modulation schemes, as would be known to one of skill in the art, after gaining a thorough understanding of the full disclosure, may be employed.

Hereinafter, the magnetic card reader 10 and an operation thereof according to an embodiment will be described in further detail with reference to FIGS. 2 through 4.

FIG. 2 is a block diagram illustrating a magnetic card reader according to an embodiment.

Referring to FIG. 2, the magnetic card reader 10 includes a magnetic head 210 and an analog-digital converter 220.

The magnetic head 210 generates a voltage by subtending magnetic flux. That is, the magnetic head 210 includes a receiving coil, and detects a voltage across the receiving coil generated by the changing magnetic field.

The analog-digital converter 220 generates a decoded signal from the voltage across the receiving coil. The decoded signal is, for example, a digital voltage signal, and card information data, along with other authenticating information is generated from the decoded signal.

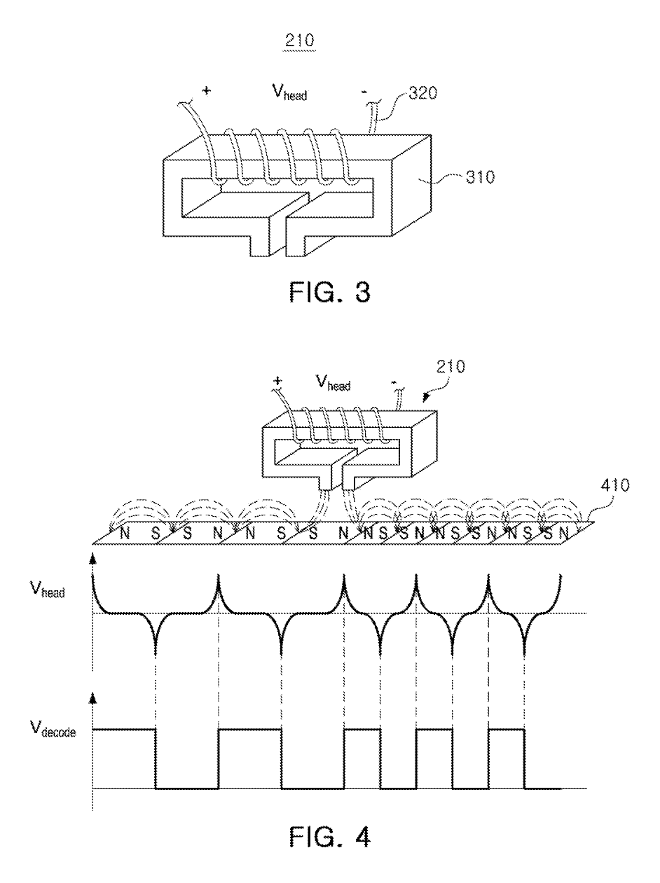

FIG. 3 is a perspective view illustrating an example of the magnetic head 210 illustrated in FIG. 2.

Referring to FIG. 3, the magnetic head 210 includes a core 310 and a receiving coil 320.

The core 310 may be formed of various materials. For example, the core 310 is formed of hard permalloy. The core 310 has, in one or more embodiments, relative permeability of about 100,000, for example.

The receiving coil 320 is wound around the core 310, and when the receiving coil 320 experiences a change in the magnetic field, a voltage V_{head} across the receiving coil 320 is generated by the magnetic flux.

The generated voltage V_{head} across the receiving coil 320 is provided to the analog-digital converter 220 (FIG. 2), and the analog-digital converter generates the decoded signal from the voltage across the receiving coil 320.

FIG. 4 is a view illustrating an example of voltage across the magnetic head adjacent to a magnetic card, such as a credit card.

The magnetic card has a magnetized magnetic stripe 410.

As the magnetic head 210 is moved over the magnetic stripe 410, the voltage V_{head} across the receiving coil of the magnetic head 210 is generated by the magnetic flux.

The voltage V_{head} across the receiving coil has a peak voltage depending on polarities of the magnetic stripe 410. For example, in a case in which the same polarities are adjacent to each other-S to S, or N to N-, the voltage V_{head} across the receiving coil has the peak voltage.

The analog-digital converter 220 (illustrated in FIG. 2) generates the decoded signal from the voltage V_{head} across the receiving coil. For example, the analog-digital converter generates an edge whenever the peak voltage is detected to generate the decoded signal V_{decode}.

The decoded signal V_{decode} is a digital voltage signal from which digital data is decoded. For example, depending on a length of a period of the decoded signal V_{decode}, a ‘1’ or ‘0’ may be decoded. It is seen from an illustrated example that a first period and a second period of the decoded signal V_{decode} are two times of a third period thereof. Therefore, the first period and the second period of the decoded signal V_{decode} are decoded to ‘1’, and a third period to a fifth period are decoded to ‘0’. Such a decoding method is illustrative, and it is should be apparent to one of skill in the art, after gaining a full understanding of the disclosure, that various decoding technologies may be applied.

FIG. 4 illustrates an example in which the magnetic card reader performs the decoding from the magnetic stripe. The magnetic head 210 is capable of generating the voltage across the receiving coil from the magnetic field generated by a transmitting coil as well as the magnetized magnetic stripe. That is, the magnetic head 210 of the magnetic card reader is magnetically coupled to the transmitting coil to receive data—e.g., card number data.

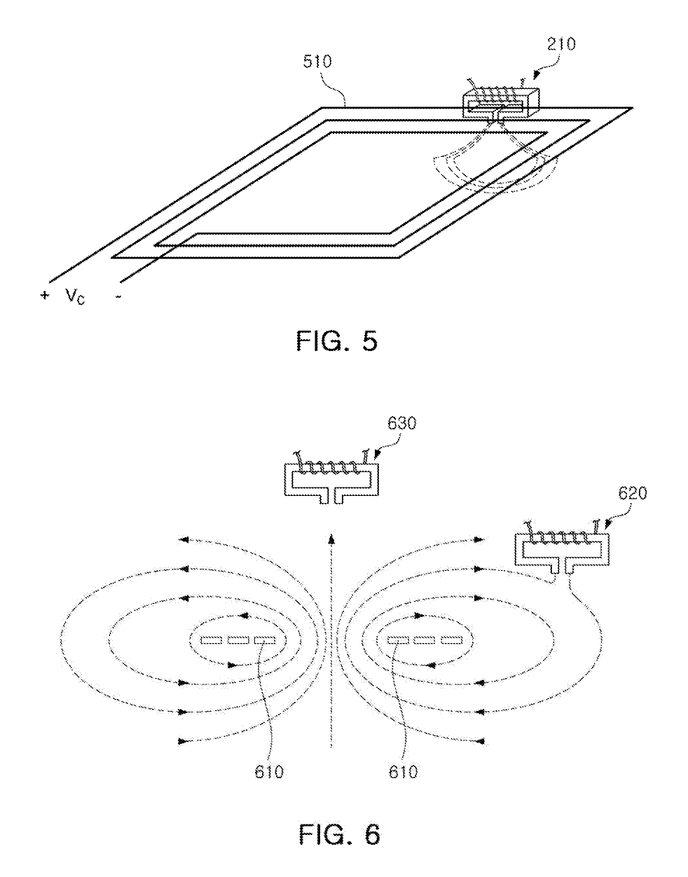

FIG. 5 is a view illustrating an example in which the magnetic head of the magnetic card reader is magnetically coupled to a transmitting coil comprising one coil.

That is, a transmitting coil 510 is applied with a voltage V_{c} to generate the magnetic field. The magnetic head 210 is magnetically coupled to the magnetic field formed by the transmitting coil 510 to receive data.

Although FIG. 5 illustrates an example in which the magnetic head 210 is positioned over a wound portion of the transmitting coil 510, a position of the magnetic head 210 is variously applied in a real-world situations for practical use.

FIG. 6 is a cross-sectional view illustrating various positions of the magnetic head which is magnetically coupled to a transmitting coil comprising one coil.

A transmitting coil 610 forms the magnetic field by a flow of current as in an illustrated example. A direction of the magnetic field is varied depending on a direction in which the current flows.

In a case in which a magnetic head 620 is positioned around the transmitting coil, the magnetic coupling between the magnetic head 620 and the transmitting coil is smoothly performed, as illustrated. One reason is that because the magnetic field formed by the transmitting coil has a closed loop shape around the transmitting coil, the magnetic field is magnetically coupled with the magnetic head 620.

In a case in which a magnetic head 630 is positioned at the center of the transmitting coil 610, the magnetic head 630 is perpendicular to a magnetic line of force as illustrated. Therefore, the magnetic coupling between the magnetic head 630 and the transmitting coil is relatively weak, or there may be no magnetic coupling therebetween.

As a result, in a case in which the transmitting coil comprises only one coil, magnetic coupling force may be decreased depending upon the position of the magnetic head, i.e., the receiving coil.

In particular, since the transmitting coil comprising only one coil is positioned at a central portion of the mobile terminal, the magnetic head of the magnetic card reader may often be positioned at a central portion of the transmitting coil. Accordingly, the magnetic coupling between the magnetic head and the transmitting coil is decreased, and there is substantial inconvenience in that the magnetic coupling between the magnetic head and the transmitting coil should be adjusted by changing the position of the mobile terminal in order to smoothly perform communications.

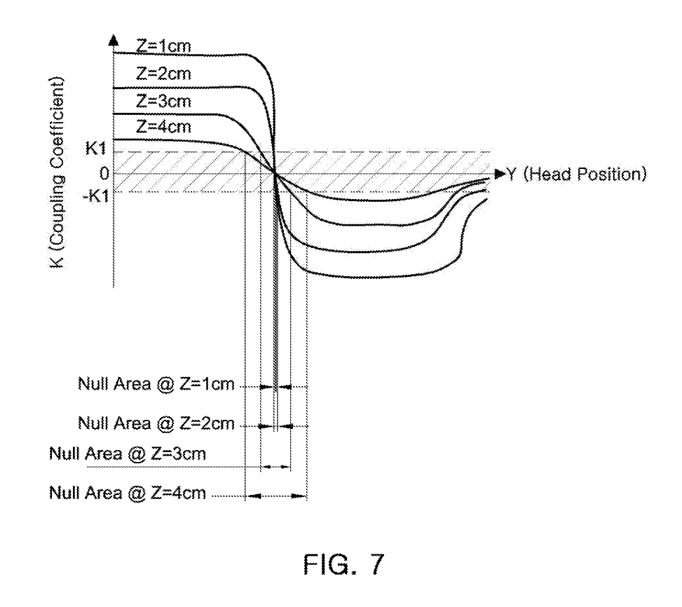

FIG. 7 is a graph illustrating communications disabled-areas, that is, null areas (indicated by a deviant crease line) depending on a distance from a central portion of the coil, in the transmitting coil illustrated in FIG. 6. The graph illustrates a coupling coefficient K depending on a distance Z between the transmitting coil and the magnetic head.

An area (indicated by a deviant crease line) corresponding to a range of the coupling coefficients from K1 to −K1 is a null area in which normal magnetic coupling is practically precluded and approaches zero, and as illustrated in FIG. 7, it is seen that as the distance between the transmitting coil and the magnetic head is increased, the null area is also increased.

The reason is that since the transmitting coil only includes one coil, the magnetic line of force formed at the center of the coil is generated in the direction perpendicular to the magnetic head, as described above. That is, in a case in which the magnetic head is positioned over the center of the transmitting coil, because the null area in which it is difficult to form the magnetic coupling exists as illustrated, reliability of the wireless communications is significantly decreased.

Hereinafter, a coil for wireless communications according to various embodiments capable of efficiently performing the wireless communications even in the above-mentioned situations will be disclosed.

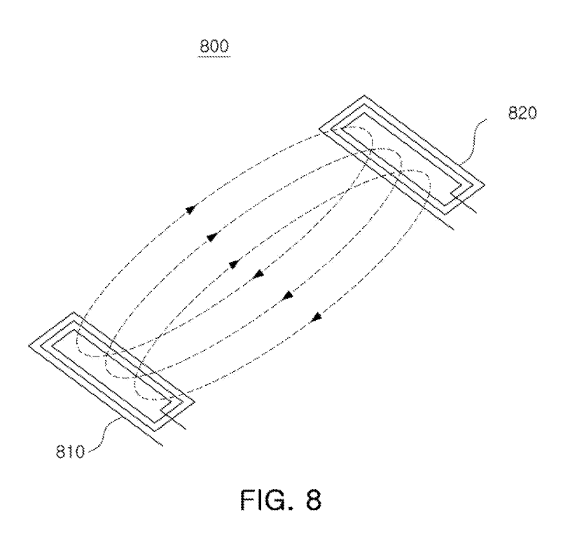

FIG. 8 is a perspective view illustrating a coil for wireless communications according to an embodiment.

Referring to FIG. 8, a coil 800 for wireless communications includes a first coil 810 and a second coil 820 spaced apart from the first coil. A metal plate may be interposed between the first coil 810 and the second coil 820.

The first coil 810 and the second coil 820 are actuated to form the magnetic field. An illustrated, the dotted lines illustrate at least a portion of a plurality of magnetic lines of force representing the magnetic field formed between the two coils. That is, the dotted line illustrates the magnetic field formed between the two coils.

The magnetic field formed between the two coils has a closed loop shape that passes through at least some regions of the first coil 810 and at least some regions of the second coil 820. In an illustrated example, the magnetic field is illustrated as a closed loop that passes through the center of the first coil 810 and the center of the second coil 820. As such, since the magnetic lines of force of the closed loop that passes through the two coils exist within the magnetic field formed through the two coils between the two coils, the receiving coil is magnetically coupled smoothly to the magnetic field even in a case in which the receiving coil is positioned at substantially any position between the two coils.

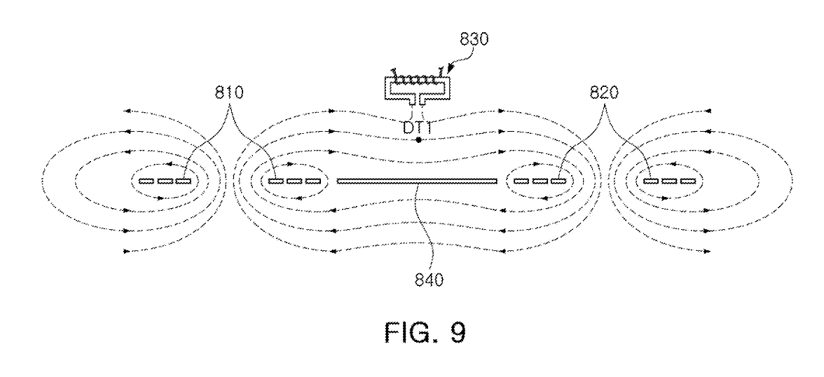

FIG. 9 illustrates a cross section of the coil for wireless communications illustrated in FIG. 8.

Referring to FIG. 9, the magnetic field is formed by the first coil 810 and the second coil 820, and a portion of the formed magnetic field is indicated by the magnetic line of force illustrated in FIG. 9.

As such, the magnetic field is formed by causing an interaction between the magnetic field formed by the first coil 810 and the magnetic field formed by the second coil 820. For example, the magnetic field formed by the first coil 810 and the magnetic field formed by the second coil 820 are reinforced with each other in a direction which is parallel to the two coils, that is, a first direction which is directed from the first coil to the second coil in the illustrated example, and thus an extended type of magnetic field passing through both the two coils such as the illustrated magnetic line of force is formed. According to an embodiment, the magnetic field formed by the first coil 810 and the magnetic field formed by the second coil 820 are reinforced with each other in a second direction directed from the second coil to the first coil, and thus the above-mentioned magnetic field is formed.

For example, when the first coil 810 and the second coil 820 are on a first plane, a first magnetic field generated by the first coil 810 and a second magnetic field generated by the second coil 820 mutually reinforce each other at at least one point DT1 on a second plane which is parallel to the first plane. This means that because two magnetic lines of force have similar directivity at at least one point DT1, the magnetic fields reinforce each other in a horizontal direction.

The magnetic field passes through both of the two coils. In the illustrated example, the magnetic field passes through the center of the first coil 810 in a first vertical direction, i.e., an upward direction, and passes through the center of the second coil 820 in a second vertical direction opposing the first vertical direction, i.e., a downward direction.

That is, referring to the illustrated example, the magnetic line of force coupled to both of the two coils upwardly penetrates through the first coil 810, moves in a direction from the first coil 810 to the second coil 820, downwardly penetrates through the second coil 820, and may be again moved in a direction from the second coil 820 to the first coil 810.

Because the magnetic field formed by the first coil 810 and the magnetic field formed by the second coil 820 are reinforced by each other in the horizontal direction of the two coils, the magnetic field formed by both of the two coils is formed in the closed loop shape that passes through both of the two coils.

According to an embodiment, a metal plate 840 is provided between the two coils.

As an example, the metal plate 840 is provided between the first coil 810 and the second coil 820 on a plane which is the same as or parallel to the first coil 810 and/or the second coil 820, as in the illustrated example. The metal plate 840, according to an embodiment, is spaced apart from the first coil 810 and the second coil 820.

Alternatively, unlike the illustrated example, the metal plate 840 may be provided to overlap at least some regions of the first coil 810 and/or at least some regions of the second coil 820. For example, the metal plate 840 may overlap at least some regions of the first coil 810 and/or at least some regions of the second coil 820, on the plane which is substantially the same as or parallel to the first coil 810 and/or the second coil 820.

As such, even in a case in which the metal plate exists between the two coils, the magnetic field is formed to pass through both of the two coils without being particularly influenced. The above-mentioned metal plate, according to one or more embodiments, is a portion of a case of a portable terminal. That is, even if a metal case exists between the two coils, the metal case may be configured to have no substantial negative effect on the magnetic field due to the placement of the coils near edges, holes, passages, slits, or conduits therethrough, and the magnetic field may be formed as illustrated.

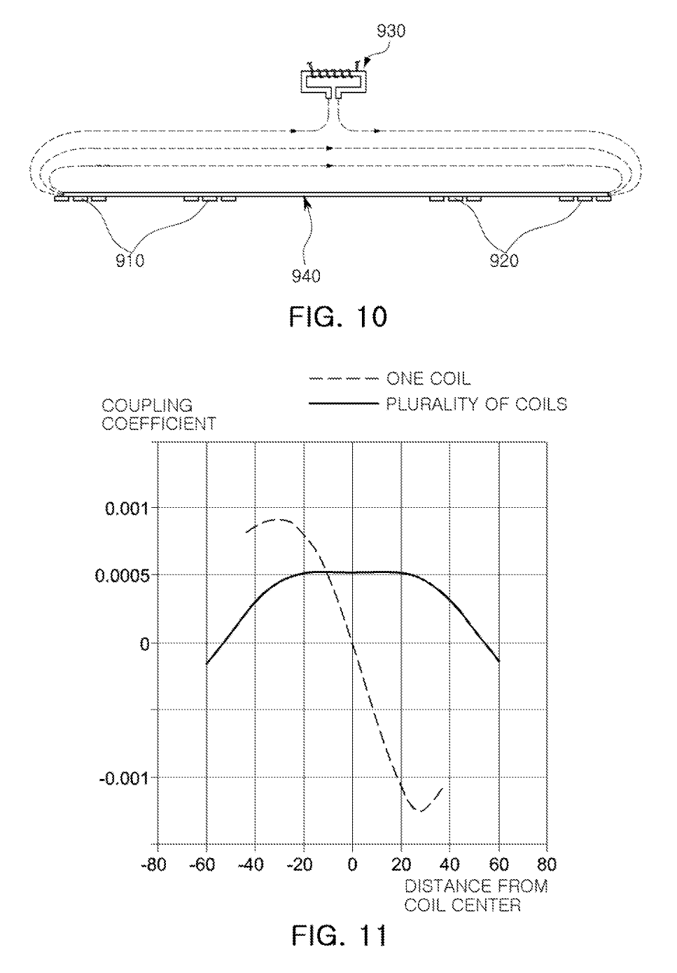

FIG. 10 is a cross-sectional view illustrating another example of the coil for wireless communications.

Referring to FIG. 10, a metal plate 940 exists over a first coil 910 and a second coil 920. The metal plate 940 overlaps at least some regions of the first coil 910 and at least some regions of the second coil 920.

Also in this case, it is seen that the magnetic field is formed in a closed loop shape that passes through at least some regions of the first coil 910 and at least some regions of the second coil 920 as illustrated.

As such, even if the metal plate 940 overlaps at least some regions of the two coils 910 and 920, a magnetic field having a wide shape that passes through the two coils is formed.

As such, since the coil for wireless communications, according to an embodiment, includes a plurality of coils which are spaced apart from each other, a wide magnetic field capable of covering the two coils, as described above, is formed. Accordingly, even in a case in which the magnetic heads 830 and/or 930 of the magnetic card reader are positioned at substantially any position proximate to the transmitting coils 910 and 920, for example, the center of the collectively-formed coil for wireless communications, the magnetic coupling between the magnetic heads 830 and 930 and the transmitting coil may be smoothly performed.

The graph illustrated in FIG. 11 illustrates coupling coefficients of the magnetic head in an example in which one coil is used as the transmitting coil, and an example in which a collectively-formed coil is used as the transmitting coil.

As illustrated in FIG. 11, in the conventional example, i.e., in a case in which only one coil is used as the transmitting coil, since as the magnetic head becomes close to the center of the coil, the coupling coefficient becomes close to 0, it may be difficult to perform the magnetic coupling between the magnetic head and the transmitting coil.

However, it is seen that because the coil for wireless communications according to an embodiment uses the a constellation of coils to collectively-form the magnetic communication field, the magnetic head has a high coupling coefficient even at a position corresponding to a center point of the arrangement of coils to be stably and magnetically coupled to the collectively-formed coil.

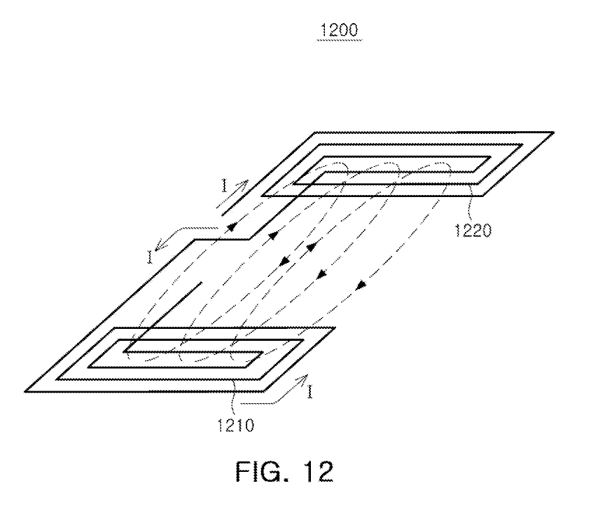

Hereinabove, the coil for wireless communications according to an embodiment has been described with reference to FIGS. 8 through 11. Hereinafter, various examples of a composite coil for wireless communications according to an embodiment will be described with reference to FIGS. 12 through 22H.

FIG. 12 is a view illustrating an example of a coil for wireless communications according to an embodiment. FIG. 12 illustrates an example in which two coils are connected in series with each other and arranged in a longitudinal arrangement substantially parallel with and substantially spanning a body of the mobile device.

Referring to FIG. 12, a coil 1200 for wireless communications includes a first coil 1210 and a second coil 1220 connected in series with the first coil 1210. Here, a winding direction of the first coil 1210 and a winding direction of the second coil 1220 are opposite to each other. For example, the first coil 1210 is wound in a clockwise direction, and the second coil 1220 is wound in a counterclockwise direction.

That is, in the case of the first coil 1210, because a current I is rotated in the clockwise direction, a magnetic field that downwardly passes through the center of the first coil 1210 is formed at the center of the first coil 1210. In contrast, in the case of the second coil 1220, because the current I is rotated in the counterclockwise direction, a magnetic field that upwardly passes through the center of the second coil 1220 is formed at the center of the second coil 1220.

As a result, it is seen that a direction of the magnetic field that passes through the center of the first coil 1210, and a direction of the magnetic field that passes through the center of the second coil 1220 are opposite to each other. The reversed winding of the two coils superimposes the two corresponding magnetic fields to be circulated through the centers of the two coils.

In contrast, in a case in which the directions of the magnetic fields that pass through the centers of the two coils are the same as each other a synergistic, reinforcing effect is not had. Because such a configuration would result in the superimposed magnetic field not circulating through the centers of the two coils, the winding directions of the two coils connected in series with each other are, instead, formed to be opposite to each other according to an embodiment, and thus the magnetic fields generated by the two coils are superimposed to be circulated through the centers of the two coils to collectively reinforce one another.

In the illustrated example, the first coil 1210 and the second coil 1220 are connected in series with each, but this is merely illustrative. Therefore, the first coil 1210 and the second coil 1220 may also be connected in parallel with each other. However, even in the case in which the first coil 1210 and the second coil 1220 are connected in parallel with each other, the direction of the magnetic field generated by the first coil 1210 and the direction of the magnetic field generated by the second coil 1220 should be opposite to each other. As a result, the two magnetic fields are reinforced with each other in the horizontal direction.

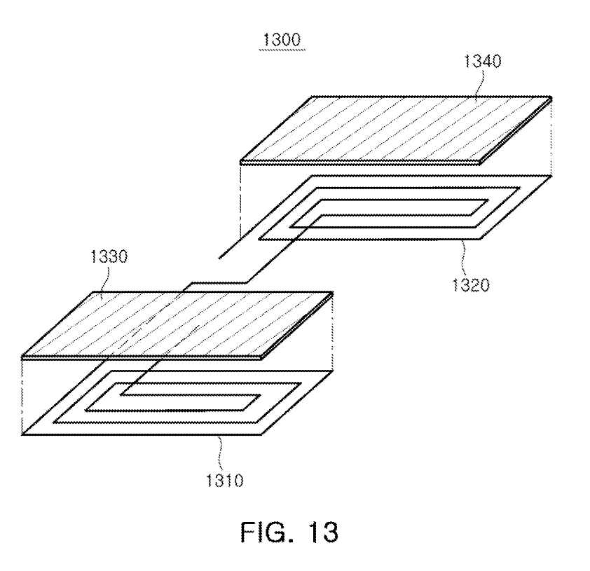

FIG. 13 is a view illustrating another example of a coil for wireless communications according to an embodiment. A coil 1300 for wireless communications illustrated in FIG. 13 relates to an embodiment in which one or more magnetic sheets are added to the coil 1200 for wireless communications illustrated in FIG. 12.

Referring to FIG. 13, the composite coil 1300 for wireless communications includes a first coil 1310 and a second coil 1320 which are connected in series with each other. The fact that the winding direction of the first coil 1310 and the winding direction of the second coil 1320 are different from each other is as described above in FIG. 11.

A first magnetic sheet 1330 is attached onto one surface of the first coil 1310, and a second magnetic sheet 1340 is attached onto one surface of the second coil 1320.

A size of the magnetic field may be increased, and/or the coupling coefficient is increased by the magnetic sheets 1330 and 1340. The magnetic sheet 1330 and 1340 may be formed of a material having magnetic permeability. For example, the magnetic sheets 1330 and 1340 may be formed of a material such as a nano crystal material, a ferrite material, or an amorphous material.

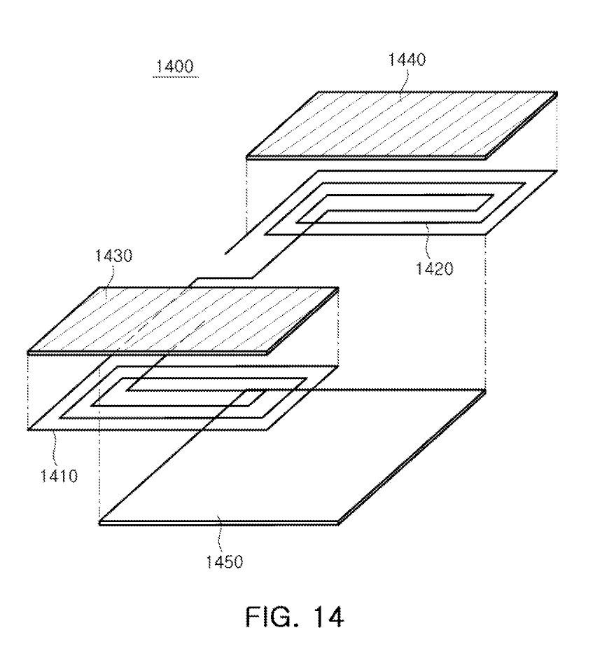

FIG. 14 is a view illustrating another example of a coil for wireless communications according to an embodiment. A coil 1400 for wireless communications illustrated in FIG. 14 relates to an embodiment in which a metal plate is added to the coil 1300 for wireless communications illustrated in FIG. 13.

Referring to FIG. 14, the coil 1400 for wireless communications includes a first coil 1410 and a second coil 1420 which are connected in series with each other. The fact that the winding direction of the first coil 1410 and the winding direction of the second coil 1420 are different from each other is as described above in FIG. 11.

According to an embodiment, a first magnetic sheet 1430 is attached onto one surface of the first coil 1410, and a second magnetic sheet 1440 is attached onto one surface of the second coil 1420.

A conductive material, for example, a metal plate 1450is disposed between the first coil 1410 and the second coil 1420.

The metal plate 1450 is provided on a plane which is substantially the same as or substantially parallel to the first coil 1410 or the second coil 1420, and provided between the first coil 1410 and the second coil 1420. The metal plate 1450 allows the magnetic fields generated by the two coils, respectively, to be easily reinforced with each other in the horizontal direction.

The metal plate 1450 has a polygonal shape having a first length and a second length in a first direction and a second direction respectively. The illustrated example illustrates an example in which the metal plate 1450 has a rectangular shape. Here, the first length is a length of a first direction directed from the first coil to the second coil, and the second length is a length of a second direction perpendicular to the first direction. The first length is longer than the second length.

That is, as in the illustrated example, when the two coils are at a right and a left of the metal plate 1450, a horizontal length of the metal plate 1450 is longer than a vertical length thereof. The reason is that the magnetic fields generated by the two coils, respectively, are more easily reinforced by each other in the horizontal direction, in such a configuration, so that the metal plate 1450 widely covers a central portion of the two coils. Therefore, the metal plate 1450 has a shape in which a length in the first direction corresponding to a distance between the two coils is long. Long may be defined as substantially the length of a mobile device, such as a smart phone, smart watch, or other wearable device or portable terminal.

Although the metal plate 1450 is illustrated as a rectangular shape contacting with the two coils in the illustrated example, this is merely illustrative. Therefore, the metal plate 1450, according to other configurations, is implemented as a smaller polygon positioned between the two coils.

The metal plate 1450, according to some configurations, does not overlap the first and second magnetic sheets 1430 and 1440, thereby significantly reducing a mutual influence.

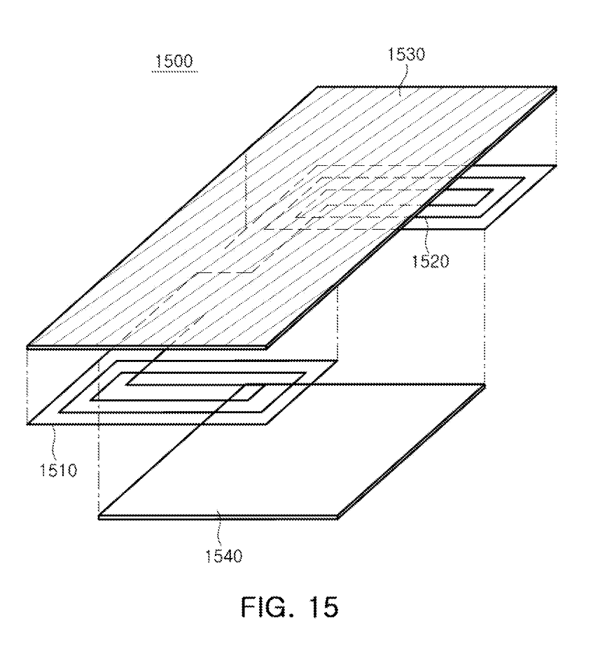

FIG. 15 is a view illustrating another coil for wireless communications according to an embodiment.

A composite coil 1500 for wireless communications illustrated in FIG. 15 relates to an example in which a plurality of magnetic sheets 1430 and 1440, from the example of the composite coil 1400 for wireless communications illustrated in FIG. 14, are substituted with one magnetic sheet 1530.

According to an embodiment, another coil may be provided between a first coil 1510 and a second coil 1520. For example, a coil for wireless charging, or a coil for wireless communications, such as near field communications (NFC) coil, may be provided between the first coil 1510 and the second coil 1520. As such, in a case in which various coils are provided, one magnetic sheet 1530 may cover the various coils as illustrated, rather than including a separate magnetic sheet for each of the coils.

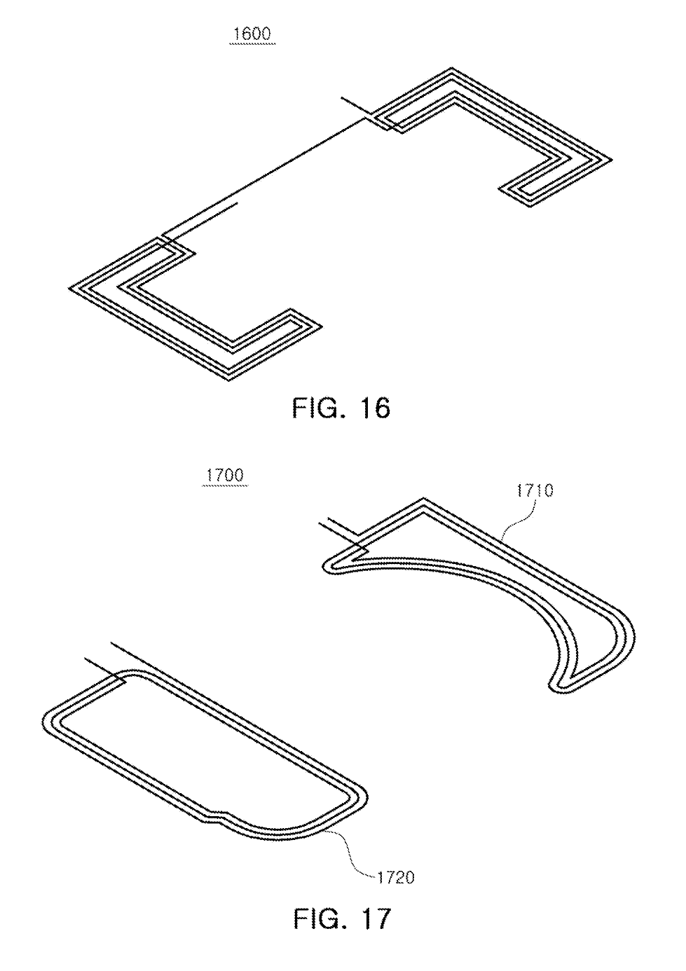

Hereinabove, in the examples in which the description is provided with reference to FIGS. 8 through 15, the coils wound in a quadrangular shape are illustrated. However, those examples are merely illustrative, and the coil may be wound in various shapes. Hereinafter, various coil shapes will be described with reference to FIGS. 16 through 19.

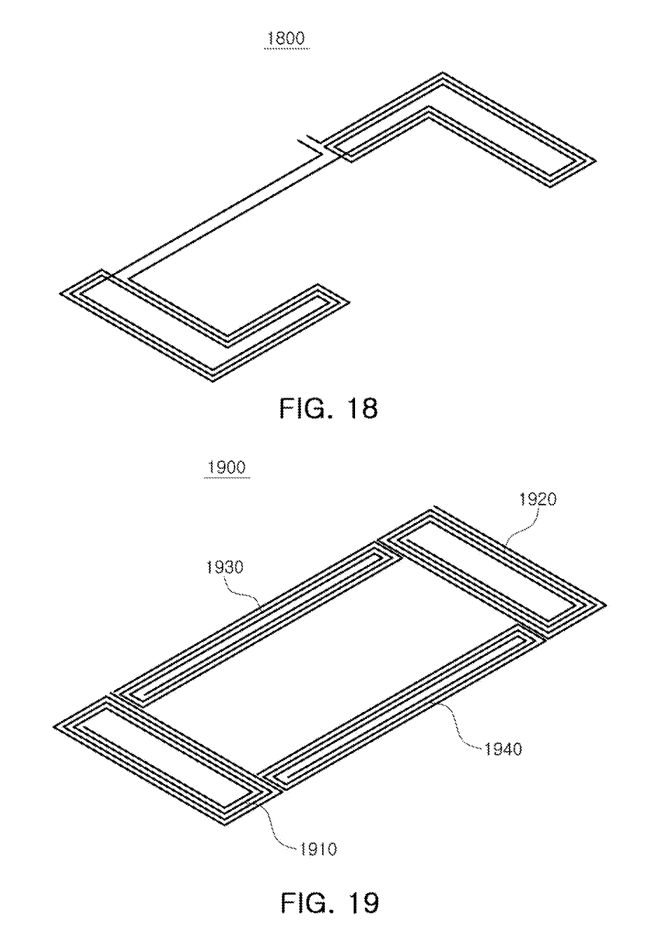

FIG. 16 is a view illustrating a composite coil 1600 for wireless communications including a coil wound in a ‘π’ shape, according to an embodiment and FIG. 17 illustrates a composite coil 1700 for wireless communications wound in an asymmetrical shape, according to an embodiment. FIG. 18 illustrates a composite coil 1800 for wireless communications including a coil wound in a ‘r”’ shape, according to an embodiment.

The composite coil 1600 for wireless communications illustrated in FIG. 16 is configured by connecting displaced coils wound in the shape of ‘π’ of both side surfaces in series with each other. However, according to an embodiment as described above, the two coils may also be configured to be connected in parallel with each other.

In an example illustrated in FIG. 17, it is seen that a first coil 1710 and a second coil 1720 of composite coil 1700 have an asymmetrical shape. In addition, according to one or more embodiments, the first coil 1710 and the second coil 1720 are also asymmetrically wound. Because the shape of the first coil 1710 and the second coil 1720 are determined depending on a shape of a terminal to which the coil 1700 for wireless communications is applied, the shape of the first coil 1710 and the second coil 1720 are variously determined. In addition, coils of other applications (e.g., a coil for wireless charging, and the like) are also provided between the first coil 1710 and the second coil 1720, and the shape of the first coil 1710 and the second coil 1720 are variously determined depending on shapes of the coils of other applications.

The composite coil 1800 for wireless communications illustrated in FIG. 18 is configured by connecting coils wound in the ? shape of both side surfaces in series with each other, according to an embodiment. However, according to other embodiments, as described above, the two coils are configured to be connected in parallel with each other.

As illustrated in FIGS. 16 through 18, the coils are formed in various shapes. In addition, in a case in which the coil is wound in the ‘r” shape, the ‘π’ shape, or the asymmetrical shape, the magnetic field generated by the corresponding coil is more widely spread. Therefore, even if a direction of the receiving coil such as the magnetic head is oriented in substantially any direction, the magnetic coupling may be smoothly performed.

FIG. 19 illustrates a composite coil 1900 for wireless communications including three or more coils according to an embodiment.

In an illustrated example, a first coil 1910 and a second coil 1920, depending upon embodiment, are connected in series or in parallel with each other. A direction of a current flowing in the first coil 1910 is established to be opposite to a direction of a current flowing in the second coil 1920. As a result, one or more magnetic lines of force that pass through both the first coil 1910 and the second coil 1920 are generated.

In addition, according to an embodiment, a third coil 1930 and a fourth coil 1940 are connected in series or in parallel with each other. A direction of a current flowing in the third coil 1930 is established to be opposite to a direction of a current flowing in the fourth coil 1940, for example. As a result, one or more magnetic lines of force that pass through both the third coil 1930 and the fourth coil 1940 are be generated to be mutually reinforced.

Meanwhile, the magnetic field is collectively formed to be widely spread on a plane which is substantially parallel to the coils and extending over substantially all of the surface area of a portable terminal, mobile device or wearable device incorporating the composite coil, by the first coil 1910 to the fourth coil 1940. As such, the composite coil 1900 for wireless communications includes three or more coils, and variously adjusts a region which is covered by the magnetic field, accordingly.

In the embodiments described above, the coils for wireless communications have been described in relation to the examples in which the plurality of coils are connected in series with each other.

According to one or more embodiments, the composite coil for wireless communications is configured by connecting the plurality of coils in parallel with each other. Even in the case in which the plurality of coils are connected in parallel with each other, a magnetic line of force that passes through the center of one coil and is moved upwardly is generated from one coil, and a magnetic line of force that passes through the center of another coil and is moved downwardly is generated from another coil to provide mutual reinforcement of the collectively-formed magnetic field.

For example, in a case in which the first coil and the second coil (which are connected in parallel to each other) are wound in the same direction (e.g., the clockwise direction), the current in the first coil flows in the clockwise direction, and the current in the second coil flows in the counterclockwise direction.

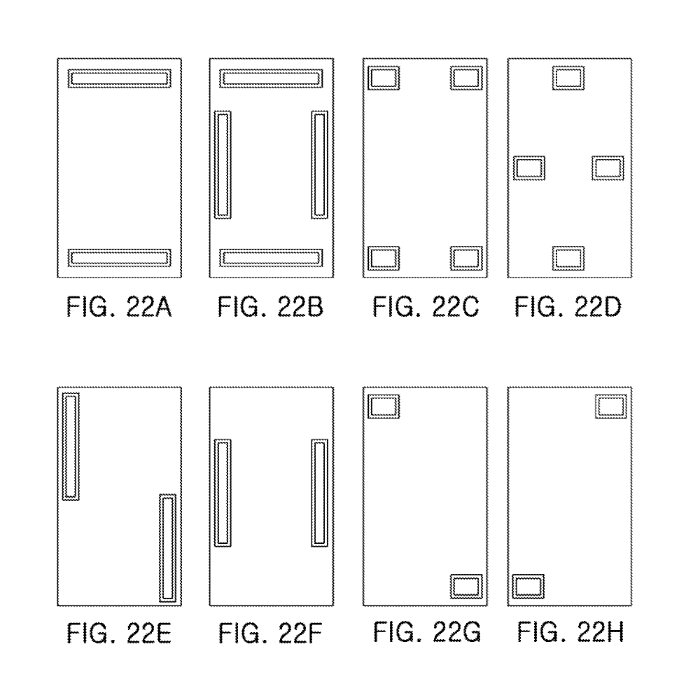

The magnetic field that passes through the center of one coil and is moved upwardly, for example, in the Z direction, out of the page (as illustrated in FIG. 22A-H) is generated from one coil, and the magnetic field that passes through the center of another coil and is moved downwardly, for example, in the Z direction into the page, is generated from another coil, by selectively setting a winding direction and/or a flow direction of the current to be different between the two coils, and thus an overlapping magnetic field is more widely distributed to provide for.

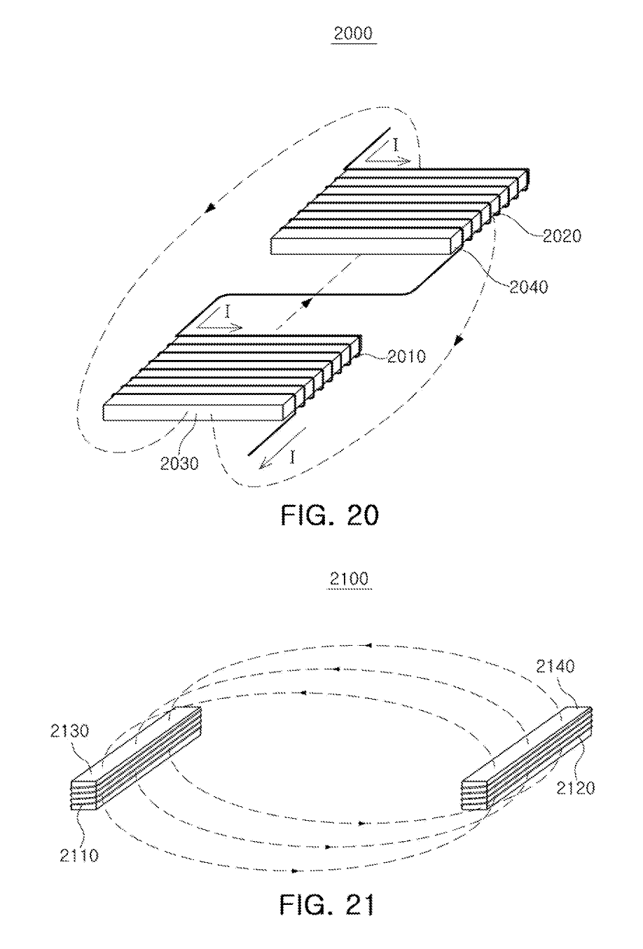

Hereinabove, although a winding type coil has been described, the coil for wireless communications may also be configured of various different kinds of coils. Hereinafter, a coil for wireless communications including a solenoid coil will be described with reference to FIGS. 20 and 21.

FIG. 20 is a view illustrating an example of a coil for wireless communications using a solenoid. A coil 2000 for wireless communications illustrated in FIG. 20 relates to an embodiment using a horizontal type solenoid.

Referring to FIG. 20, the composite coil 2000 for wireless communications includes a first solenoid including a first coil 2010 wound around a first magnetic body 2030, and a second solenoid including a second coil 2020 wound around a second magnetic body 2040.

The first coil 2010 is a solenoid coil wound around the first magnetic body 2030 about a first axis direction, and the second coil 2020 is a solenoid coil wound around the second magnetic body 2040 about the first axis direction. That is, the first coil 2010 and the second coil 2020 are coaxially wound in relation to the same central axis.

Because the first solenoid and the second solenoid are connected in series with each other and a current flows in the same direction, the magnetic field flows as in an illustrated magnetic line of force. That is, the magnetic line of force directed from the first solenoid to the second solenoid exists in a space between the first solenoid and the second solenoid. The magnetic line of force that exits from the first solenoid and enters the second solenoid exists in a peripheral space of the first solenoid and the second solenoid. Although only a portion of the magnetic field is illustrated as the magnetic line of force in the illustrated example, this is merely for purpose of description clarity and conciseness. Therefore, the magnetic field is not limited by the magnetic line of force.

Similarly, because the magnetic field is formed to be widely spread out in upper spaces of two solenoids or lower spaces thereof in the present embodiment, a region which is able to be magnetically coupled to the receiving coil is widely formed as in the embodiments described above.

FIG. 21 is a view illustrating another example of a coil for wireless communications using one or more solenoids. A composite coil 2100 for wireless communications, as illustrated in FIG. 21, relates to an embodiment using a vertical type solenoid, as opposed to the co-axial arrangement of FIG. 20.

As illustrated in FIG. 21, a first solenoid includes a first coil 2110 wound around a first magnetic body 2130, and a second solenoid includes a second coil 2120 wound around a second magnetic body 2140.

The first coil 2110 is a solenoid coil wound around the first magnetic body 2130 about a first axis direction, and the second coil 2120 is a solenoid coil wound around the second magnetic body 2140 about a second axis direction which is substantially parallel to the first axis direction. That is, a central axis of the first coil 2010 and a central axis of the second coil 2020 are established to be parallel to each other.

As such, even in a case in which the vertical type solenoid is used, in order to widely form the magnetic field, it a direction of a current flowing in the first coil 2110 and a direction of a current flowing in the second coil 2120 are opposite to each other or a directions of winding are opposite from each other.

FIGS. 22A through 22H are reference views illustrating various layouts of solenoid coils.

The vertical type solenoid illustrated in FIG. 21 as well as the horizontal type solenoid illustrated in FIG. 20, according to one or more embodiments, are applied to FIGS. 22A through 22H.

As illustrated in FIGS. 22A through 22H, the solenoids are disposed in various arrangements according to the embodiments, and may be provided to be symmetrical to each other in at least some regions, thereby forming a more widely extended magnetic field.

In the case in which the solenoid coil is used, since the solenoid coil is able to be miniaturized as needed, the coil for wireless communications according to an embodiment may also be easily applied to a small application such as a smart watch, smart glasses, smart ring, keyring fob, transaction token, or other wearable device.

As described above, the composite coil for wireless communications according to an embodiment may include any of the various modified examples. In addition, although not illustrated in the drawings, a combination of various coils forming a magnetic field including a magnetic line of force extended in a direction which is parallel to a plurality of coils by using the coils is also included in a scope of the description.

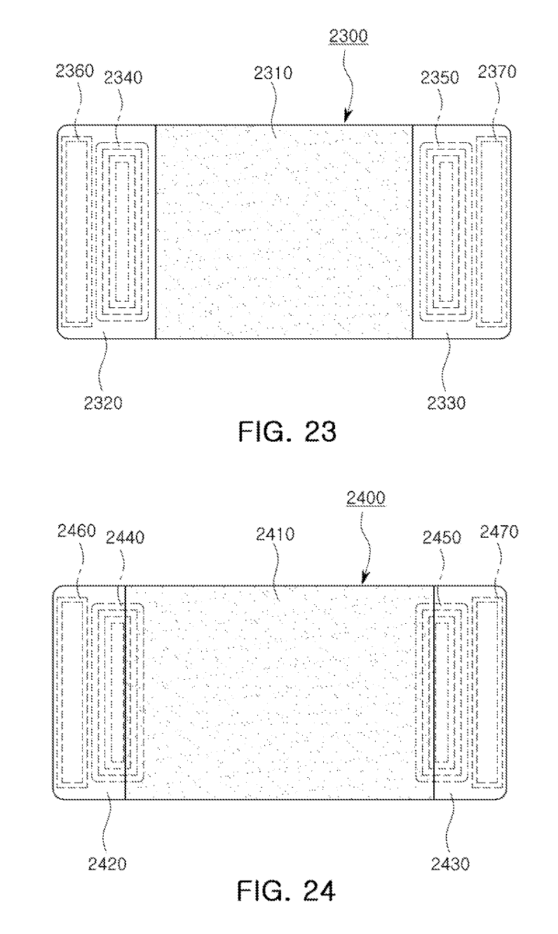

Hereinafter, various embodiments of a mobile terminal to which the coil for wireless communications described above is applied will be described with reference to FIGS. 23 through 28.

FIG. 23 is a view illustrating an example of a mobile terminal according to an embodiment.

Referring to FIG. 23, the mobile terminal includes a housing 2300 and coils 2340 and 2350 for wireless communications.

In addition to those coils, the mobile terminal further includes various components such as a communications module, a display device, speaker, microphone, and interface device such as a touchscreen. The housing 2300 includes a metal part 2310 and non-metal parts 2320 and 2330. The non-metal parts 2320 and 2330 are formed, for example, at both ends of the metal part 2310.

The metal part 2310 and the non-metal parts 2320 and 2330 may also be produced as one whole assembly by an injection molding process, or may also be separately produced and then assembled.

The coils for wireless communications include a first coil 2340 and a second coil 2350.

The first coil 2340 and the second coil 2350 are spaced apart from each other in a length direction of the housing 2300, and are affixed to the housing. The coils 2340 and 2350 for wireless communications may be understood from those described above with reference to FIGS. 8 through 22H.

At least some regions of the first coil 2340 and at least some regions of the second coil 2350 overlap the non-metal parts 2320 and 2330, but at least some portion does not overlap, according to an embodiment. In a case in which the entirety of regions of the first coil 2340 and the second coil 2350 are covered by the metal part, the first coil 2340 and the second coil 2350 are influenced by the metal part, and the magnetic field is not sufficiently formed. Therefore, when at least some regions of the first coil 2340 and at least some regions of the second coil 2350 overlap the non-metal parts 2320 and 2330, because the corresponding non-metal parts define a passage through which the magnetic field passes, the magnetic field is formed to be sufficiently widened. In the illustrated example, the entirety of regions of the first coil 2340 and the second coil 2350 are disposed in registration with the non-metal parts.

In the illustrated example, a rear surface of the housing 2300 is illustrated. According to one or more embodiments, at least a portion of the rear surface of the housing 2300 is detachable, or is formed integrally with a front surface of the housing 2300.

The metal part 2310 is formed of a metal material, and the non-metal parts 2320 and 2330 are formed of a non-metal material.

The mobile terminal further includes antennas 2360 and 2370 for wireless communications.

The coils 2340 and 2350 for wireless communications and the antennas 2360 and 2370 for wireless communications overlap the non-metal parts 2320 and 2330 in order to more smoothly perform communications.

FIG. 24 is a view illustrating another example of a mobile terminal.

Referring to FIG. 24, the mobile terminal includes a housing 2400 and coils 2440 and 2450 for wireless communications. According to one or more embodiments, the mobile terminal further includes antennas 2460 and 2470 for wireless communications.

As illustrated, a first coil 2440 and a second coil 2450 overlap a metal part 2410 and non-metal parts 2420 and 2430.

That is, at least some regions of the first coil 2440 and at least some regions of the second coil 2450 overlap the non-metal parts 2420 and 2430, and the remaining regions of the first coil 2440 and the remaining regions of the second coil 2450 overlap the metal part 2410.

That is, as described above with reference to FIG. 10, even though some regions of the coils 2440 and 2450 for wireless communications overlap the metal part 2410, the magnetic line of force having the closed loop shape flow in at least some regions of the first coil 2440 and at least some regions of the second coil 2450.

Therefore, since a length of the metal part 2410 is formed to be longer in the present example, a degree of freedom is secured.

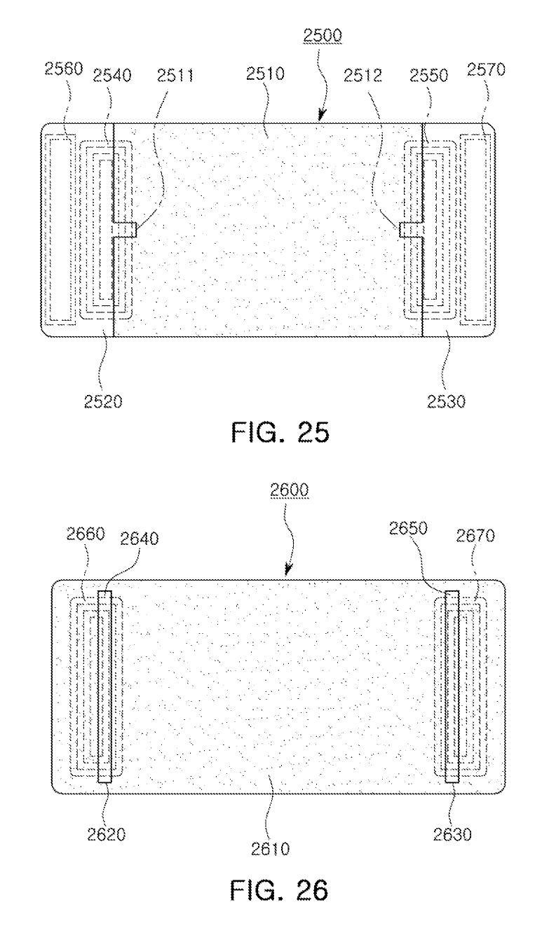

FIG. 25 is a view illustrating another example of a mobile terminal according to an embodiment.

Referring to FIG. 25, the mobile terminal includes a housing 2500 and coils 2540 and 2550 for wireless communications. According to one or more embodiments, the mobile terminal further includes antennas 2560 and 2570 for wireless communications.

The housing 2500 includes one or more slits 2511 and 2512 in a metal part 2510.

That is, the metal part 2510 includes one or more slits 2511 and 2512 formed in regions that overlap a first coil 2540 and a second coil 2550.

The slits 2511 and 2512 overlap at least some regions of the first coil 2540 or at least some regions of the second coil 2550. Portions of the non-metal parts 2520 and 2530 are formed in a shape of the slit.

Therefore, the slits 2511 and 2512 serve as passages or conduits through which magnetic fields formed by the first coil 2540 and the second coil 2550 pass. As a result, even though the metal part 2510 is configured to overlap a significant portion of the first coil 2540 and a significant portion of the second coil 2550, the magnetic field is formed by the slits 2511 and 2512.

FIG. 26 is a view illustrating another example of a mobile terminal, which illustrates an example of a metal part including a through hole.

Referring to FIG. 26, a housing 2600 includes a metal part 2610 and one or more through holes 2620 and 2630.

The through holes 2620 and 2630, according to an embodiment, are empty spaces defined in the metal part 2610, and non-metal parts 2640 and 2650 are disposed in the corresponding space. That is, shapes of the non-metal parts 2640 and 2650 correspond to shapes of one or more through holes 2620 and 2630.

At least some regions of a first coil 2660 and at least some regions of a second coil 2670 overlap at least some of the through holes 2620 and 2630, respectively. Therefore, the through holes 2620 and 2630 serve as passages through which magnetic fields formed by the first coil 2660 and the second coil 2670 flow.

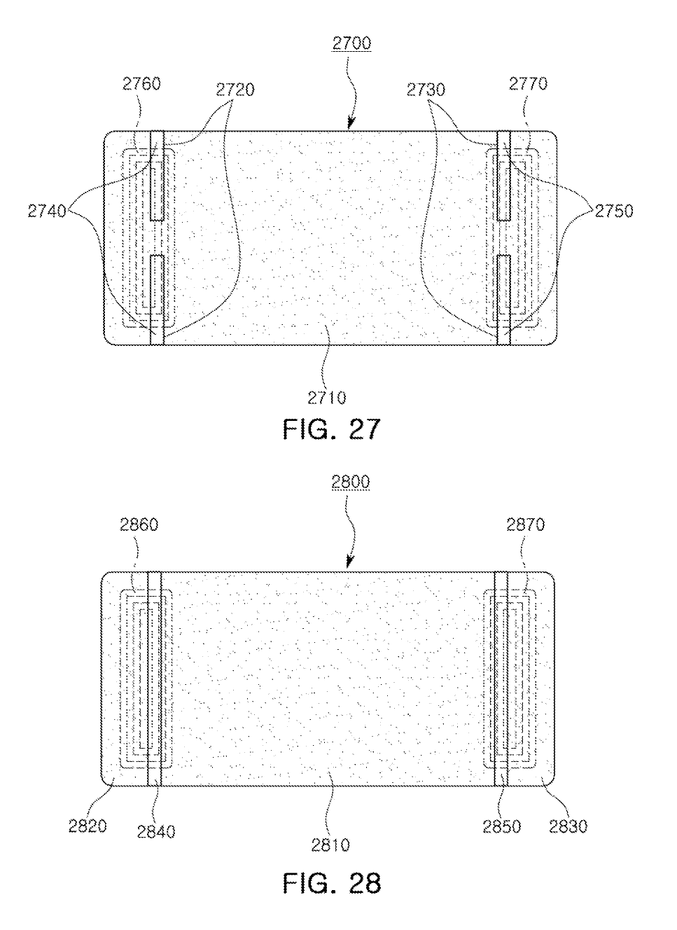

FIG. 27 is a view illustrating another example of a mobile terminal, according to an embodiment, which illustrates an example of a metal part including a slit.

Referring to FIG. 27, a housing 2700 includes a metal part 2710 and one or more slits 2720 and 2730 defined through the metal part 2710.

Interiors of the slits 2720 and 2730, according to one or more embodiments, are empty space, and non-metal parts 2740 and 2750 are disposed in the corresponding space. That is, shapes of the non-metal parts 2740 and 2750 respectively correspond to shapes of one or more slits 2720 and 2730.

At least some regions of a first coil 2760 and at least some regions of a second coil 2770 respectively overlap with at least some of the slits 2720 and 2730. Therefore, the slits 2720 and 2730 serve as passages through which magnetic fields formed by the first coil 2760 and the second coil 2770 flow.

FIG. 28 is a view illustrating another example of a mobile terminal, according to an embodiment, which illustrates an example of a metal part including a plurality of metal plates.

Referring to FIG. 28, a housing 2800 includes a plurality of metal plates, for example, a first metal plate 2810, a second metal plate 2820, and a third metal plate 2830 in the illustrated example. The first metal plate 2810, the second metal plate 2820, and the third metal plate 2830 are separated from each other.

A non-metal part includes one or more non-metal plates 2840 and 2850. The non-metal plates 2840 and 2850 are provided between the plurality of metal plates 2810, 2820, and 2830 which are separated from each other.

At least some regions of a first coil 2860 and at least some regions of a second coil 2870 overlap at least some of the non-metal plates 2840 and 2850. Therefore, the non-metal plates 2840 and 2850 serve as passages through which magnetic fields formed by the first coil 2860 and the second coil 2870 flow.

As described above, the housing includes the metal part in addition to the non-metal parts, and even in a case in which the metal part exists, some of the coil for wireless communications overlaps the non-metal parts, and thus the magnetic field is effectively formed. As a result, despite the housing being formed of a metal, stable performance is provided.

According to an embodiment, A mobile terminal may transmit a transmission signal to a receiving coil using a first magnetic field, the mobile terminal may comprise a first coil, a second coil spaced apart from the first coil and a housing including a metal plate formed between the first coil and the second coil. The first coil and the second coil may form the first magnetic field.

A line of magnetic force representing the first magnetic field has a closed loop shape that passes through the first region of the first coil and the first region of the second coil.

The composite coil may include a third coil formed on one surface of the metal plate to form a second magnetic field, different from the first magnetic field, and the composite coil may receive power or the signal wirelessly via the second magnetic field. Third coil may be any one of a coil for wireless charging and a near field communications (NFC) coil.

The composite coil may further include a magnetic sheet covering the first coil to the third coil.

The metal plate may comprise a slit or a through hole, and the slit or the through hole overlaps the region of the first coil or the region of the second coil.

The first coil may be wound in a clockwise direction, the second coil may be wound in a counterclockwise direction, and the first and second coils may be configured to have a current flowing in the clockwise direction in the first coil and in the second coil.

The first coil and the second coil may be wound in a clockwise direction, the first coil may be configured to have a current flowing in the clockwise direction, and the second coil may be configured to have a current flowing in a counterclockwise direction.

As a non-exhaustive example only, a mobile terminal or device, as described herein, may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device configured to perform wireless or network communication. In one example, a wearable device is a device that is configured to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

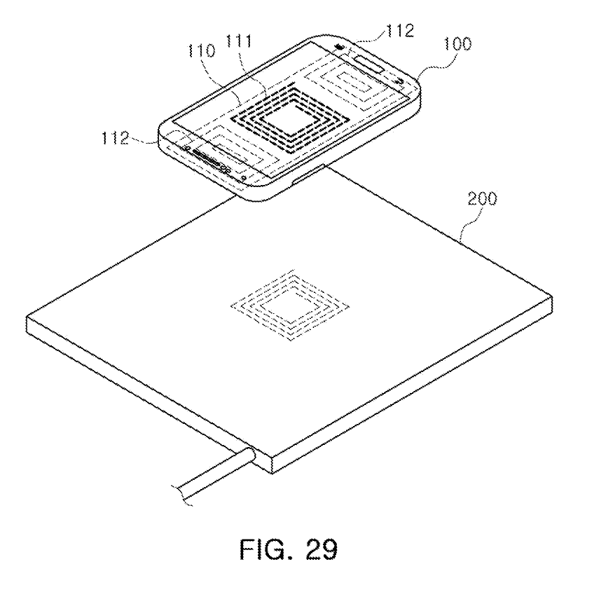

FIG. 29 is a perspective view illustrating an example of a mobile terminal to which a coil module according to an embodiment is applied. In an example illustrated in FIG. 29, the mobile terminal may perform wireless charging.

Referring to FIG. 29, the mobile terminal 100 may include a coil module 3110, and the coil module 3110 may include a coil 111 for wireless charging and a coil 112 for wireless communications.

The coil 111 for wireless charging may be a coil wound a plurality of times, and may be magnetically coupled to a wireless power transmitter 200 to wirelessly receive power. Although not illustrated, the coil 111 for wireless charging may be connected to a capacitor to configure a resonant circuit on a receiving side, and may be magnetically coupled to a resonant circuit on a transmitting side of the wireless power transmitter 200.

According to an embodiment, a composite coil may transmit a signal wirelessly via a first magnetic field and wirelessly receiving power or the signal via a second magnetic field, the composite coil may comprise a first coil, a second coil spaced apart from the first coil and a third coil formed between the first coil and the second coil. The first coil and the second coil may form the first magnetic field, and the third coil may form the second magnetic field, different from the first magnetic field.

The line of magnetic force of the first magnetic field may have a closed loop shape that passes through a region of the first coil and a region of the second coil. The first coil may form a third magnetic field, the second coil may form a fourth magnetic field, and the first magnetic field may be formed by the third magnetic field and the fourth magnetic field interacting with each other.

The composite coil may further comprise a magnetic sheet covering the first coil to the third coil. The third coil may be any one of a coil for wireless charging and a near field communications (NFC) coil.

The first coil may be wound in a clockwise direction, the second coil may be wound in a counterclockwise direction, and the first coil and the second coil may be configured to have a current flowing in the first coil and a current flowing in the second coil flowing in the clockwise direction.

The first coil and the second coil may be wound in a clockwise direction, the first coil may be configured to have a current flowing in the clockwise direction, and the second coil may be configured to have a current flowing in a counterclockwise direction.

The first coil may be a solenoid coil wound around a first magnetic body in a first axis direction, and the second coil may be a solenoid coil wound around a second magnetic body in a second axis direction which is substantially the same as or substantially parallel to the first axis direction.

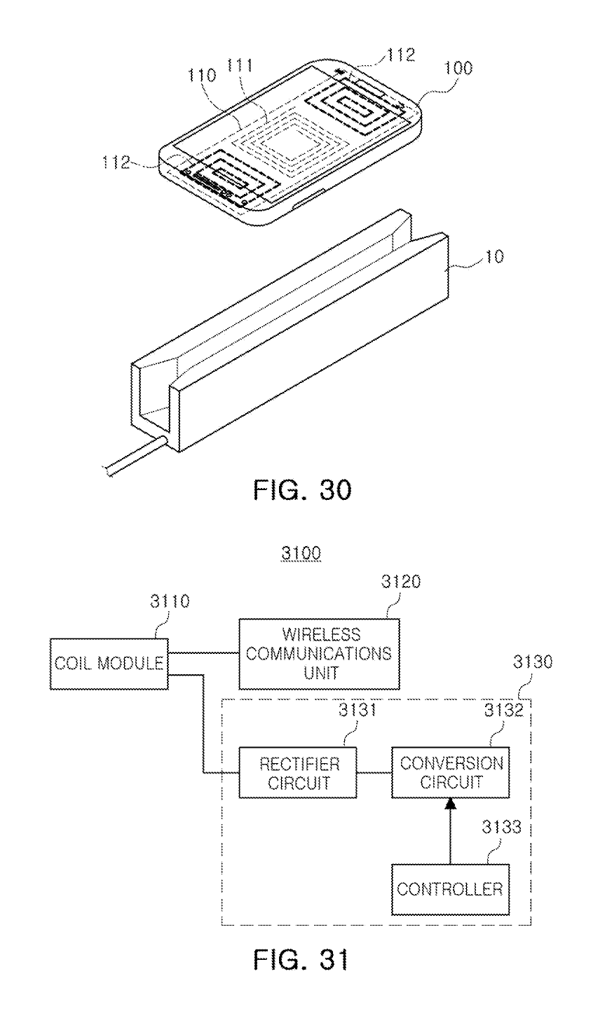

FIG. 30 is a perspective view illustrating an example of a mobile terminal to which a coil module according to an embodiment is applied. In an example illustrated in FIG. 30, the mobile terminal may perform wireless communications.

Referring to FIG. 30, the mobile terminal 100 may include a coil module 3110, and the coil module 3110 may include a coil 111 for wireless charging and a coil 112 for wireless communications.

The coil 112 for wireless communications may perform communications with a wireless communication device wirelessly. FIG. 30 illustrates an example in which the coil 112 for wireless communications performs communications with a magnetic card reader 10 wirelessly.

In general, because the magnetic card reader is used to read a magnetic strip of a magnetic card to identify data, the magnetic card reader is not used for communications. However, the coil 112 for wireless communications according to an embodiment may wirelessly provide predetermined data—e.g., a card number or the like—to the magnetic card reader 10, by providing magnetic characteristics similar to the magnetic strip of the magnetic card to the magnetic card reader 10.

According to an embodiment, the coil 112 for wireless communications may include a plurality of coils, and such a plurality of coils may form a single magnetic field. In other words, the plurality of coils included in the coil 112 for wireless communications may form a widespread magnetic field. As a result, even if positions or angles between the plurality of coils and the magnetic card reader 10 are changed, the plurality of coils may provide stable wireless communications.

Hereinafter, various embodiments of a coil module and a mobile terminal using the same will be described with reference to FIGS. 31 through 37.

FIG. 31 is a block diagram illustrating a mobile terminal according to an embodiment.

Referring to FIG. 31, the mobile terminal 100 may include a coil module 3110, a wireless communications unit 3120, and a wireless charging unit 3130.

The coil module 3110 may include a coil for wireless communications and a coil for wireless charging.

The coil for wireless communications may be wound around a first axis, and the coil for wireless charging may be wound around a second axis, disposed perpendicular to the first axis. The coil module 3110 may include a substrate, and the coil for wireless communications and the coil for wireless charging may be formed on the substrate.

According to one or more embodiments, the coil module 3110 may further include at least one capacitor. For example, the coil module 3110 may include a resonant capacitor connected to the coil for wireless communications in series, and the coil for wireless charging and the resonant capacitor function as a resonant circuit, and may be magnetically coupled to the resonant circuit of the wireless power transmitter.

The wireless communications unit 3120 may perform wireless communications with a first device through the coil for wireless communications.

According to an embodiment, the wireless communications unit 3120 may be magnetically coupled to the magnetic card reader 10 (FIG. 30) to provide predetermined data to the magnetic card reader. The present embodiment will be described below with reference to FIG. 31.

The wireless charging unit 3130 may receive power from the wireless power transmitter wirelessly through the coil for wireless charging.

The wireless charging unit 3130 may include a rectifier circuit 3131, a conversion circuit 3132, and a controller 3133. The rectifier circuit 3131 may rectify alternating current power received through the coil module 3110. The conversion circuit 3132 may receive an output of the rectifier circuit 3131, and may transform the received output into a direct current voltage of a predetermined level desired in the mobile terminal. The conversion circuit 3132 may change an output according to a control of the controller 3133.

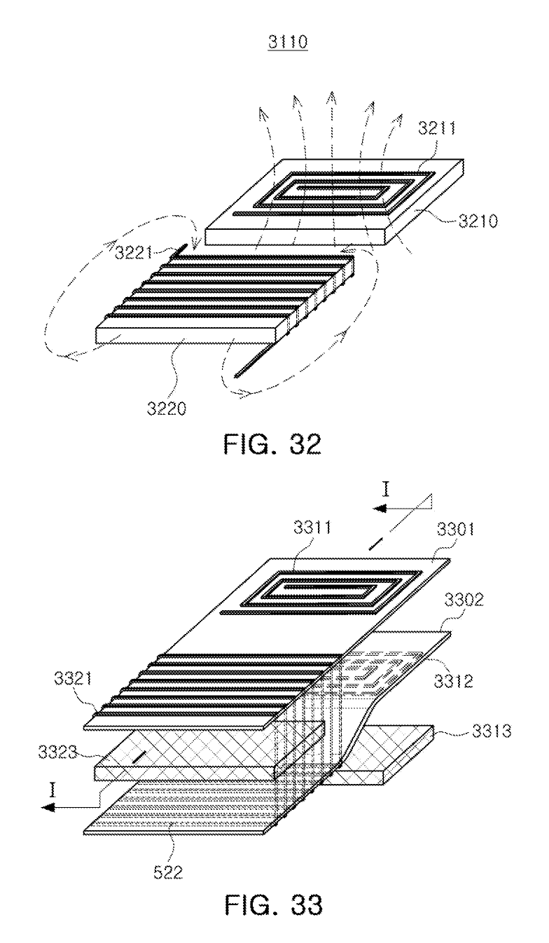

Hereinafter, various embodiments of the coil module 3110 will be described with reference to FIGS. 32 through 37.

FIG. 32 is a perspective view illustrating an example of a coil module according to an embodiment.

Referring to FIG. 32, the coil module 3110 may include a coil 3211 for wireless charging and a coil 3221 for wireless communications.

In an example, although a case in which the coil 3211 for wireless charging is formed on a first substrate 3210, and the coil 3221 for wireless communications is formed on a second substrate 3220, is illustrated, the first substrate 3210 and the second substrate 3220 may be different regions of the same substrate.

The coil 3211 for wireless charging may be wound around a first axis, that is, the first axis disposed in a direction perpendicular to the first substrate 3210 in the illustrated example, on one surface of the first substrate 3210.

Therefore, as illustrated, a first magnetic field may be formed to pass through the coil 3211 for wireless charging in the direction perpendicular to the first substrate 3210. The first magnetic field may be formed by the wireless power transmitter. That is, the coil 3211 for wireless charging may be magnetically coupled to the wireless power transmitter. Accordingly, the coil 3211 for wireless charging may receive the power from the wireless power transmitter.

The coil 3221 for wireless communications may be formed on the second substrate 3220, and may be wound around a second axis, disposed perpendicular to the first axis, that is, the second axis, parallel to the second substrate 3220 in the illustrated example.

Therefore, as illustrated, the coil 3221 for wireless communications may form a second magnetic field, at least a portion of which exits one end of the second substrate 3220 and enters the other end thereof, in a direction parallel to the second substrate 3220.

The coil 3221 for wireless communications may perform communications with an external device wirelessly, for example, the magnetic card reader 10 (FIG. 30) by means of the above-mentioned second magnetic field.

As illustrated, because the coil 3211 for wireless charging forms a magnetic field in the direction perpendicular to the substrate 3210, the coil 3211 for wireless charging may perform strong magnetic coupling with a transmit resonator of the wireless power transmitter, spaced apart from the substrate while being disposed in parallel with the substrate.

The coil 3221 for wireless communications may generate a magnetic field in a horizontal direction in order to provide a region of the magnetic field wider than the strength of the magnetic coupling, so that wireless communications may be performed at various positions. Accordingly, for example, the magnetic card reader 10 (FIG. 30) is able to smoothly perform magnetic coupling, even at various positions of the mobile terminal.

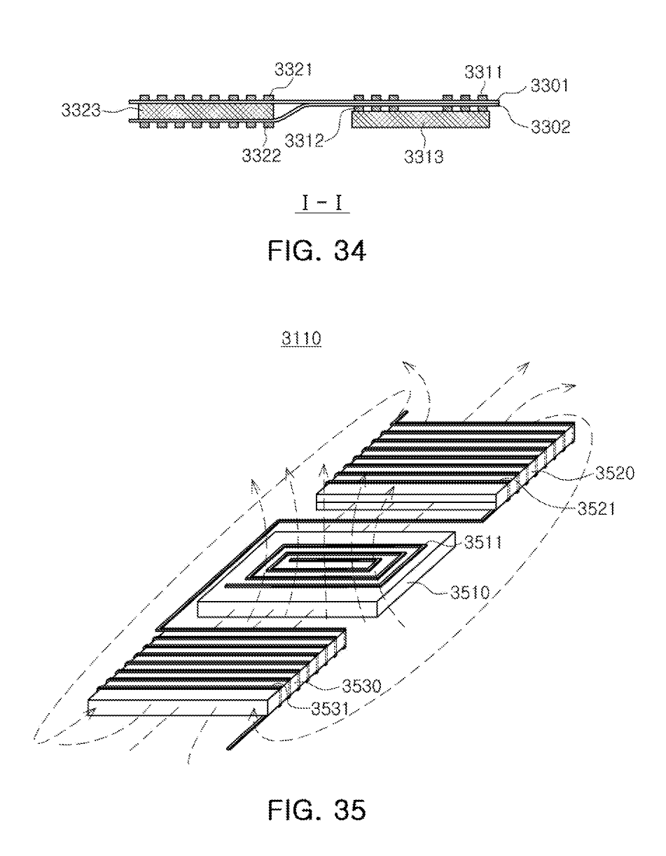

FIG. 33 is an exploded perspective view illustrating an example of a coil module formed using a multilayer substrate and FIG. 34 is a cross-sectional view of the coil module illustrated in FIG. 33, taken along line I-I.

Referring to FIG. 33, the substrate may be a flexible substrate including multiple layers, and may include a first substrate 3301 and a second substrate 3302.

Coils 3321 and 3322 for wireless communications may be formed on one region of the multilayer flexible substrate, and coils 3311 and 3312 for wireless charging may be formed on the other region thereof.

A first magnetic body 3323 may be included in one region of the multilayer flexible substrate, and the coils 3321 and 3322 for wireless communications may be solenoid coils wound around the first magnetic body 3323.

The coil 3311 for wireless charging may be formed on one surface of the other region of the multilayer flexible substrate, and a second magnetic body 3313 may be formed on the other surface of the other region thereof. In an illustrated example, although the coil 3311 for wireless charging is formed on both sides of the substrate, the coil 3311 for wireless charging according to one or more embodiments may also only be formed on one surface of the other region of the multilayer flexible substrate.

The coils for wireless charging may include a first charging coil pattern 3311, formed on one surface of the first substrate 3301.

According to one or more embodiments, as per an illustrated example, the coil for wireless charging may also include the first charging coil pattern 3311, formed on one surface of the first substrate 3301, and a second charging coil pattern 3312, formed on the other surface of the second substrate 3302. Although not illustrated, the first charging coil pattern 3311 and the second charging coil pattern 3312 may be electrically connected to each other through a via hole.

The coils 3321 and 3322 for wireless communications may include a first communications coil pattern 3321, formed on one surface of the substrate, and a second communications coil pattern 3322, formed on the other surface of the substrate.

That is, the coils 3321 and 3322 for wireless communications may also include the first communications coil pattern 3321, formed on one surface of the first substrate 3301, and the second communications coil pattern 3322, formed on the other surface of the second substrate 3302.

The first communications coil pattern 3321 and the second communications coil pattern 3322 may be electrically connected to each other through a plurality of via holes. In an illustrated example, the via holes may be formed on both sides of the first communications coil pattern 3321 and the second communications coil pattern 3322, respectively. Therefore, the first communications coil pattern 3321, the second communications coil pattern 3322, and the via holes may be implemented in solenoid form including some regions of the substrate.

The second magnetic body 3323 may be included in the solenoid formed by the first communications coil pattern 3321, the second communications coil pattern 3322, and the via holes. As illustrated, the second magnetic body 3323 may be disposed between the first substrate 3301 and the second substrate 3302.

On the other hand, the coils 3311 and 3312 for wireless charging may include the second magnetic body 3313 below the substrate.

Referring to FIG. 34, because the substrates 3301 and 3302 may be formed as a flexible substrate, the second magnetic body 3323 is included in the substrate in one region of the substrate on which the coils 3321 and 3322 for wireless communications are formed, such that the coils 3321 and 3322 for wireless communications may be formed as the solenoid.

The second magnetic body 3313 is formed to be adjacent to the other surface of the substrates 3301 and 3302 in such a manner that the coils 3311 and 3312 for wireless charging may only be formed on one side of the second magnetic body 3313.

The first magnetic body 3323 and the second magnetic body 3313 may be formed of different materials.

As an example, the first magnetic body 3313 may be formed of a material such as a ferrite material or a nanocrystal material, so that loss in wireless charging efficiency less occurs in a first frequency band—e.g., 100 kHz—used for wireless charging. The second magnetic body 3323 may be formed of a material such as a permalloy material, a mu-metal material, or a nanocrystal material, so that transmission and reception of a signal may be improved in a second frequency band—e.g., 2 kHz—used for wireless communications.

FIG. 35 is a perspective view illustrating another example of a coil module according to an embodiment.

Referring to FIG. 35, the coil module 3110 may include a coil 3511 for wireless charging and coils 3521 and 3531 for wireless communications.

Although a case in which the coil 3511 for wireless charging is formed on a first substrate 3510, a first coil 3521 is formed on a second substrate 3520, and a second coil 3531 is formed on a third substrate 3530, is illustrated, the first substrate 3510 to the third substrate 3530 may be different regions of the same substrate.

The coil 3511 for wireless charging may be wound around a first axis in the first substrate 3510, that is, the first axis, provided in a direction perpendicular to the first substrate 3210 in the illustrated example. Therefore, as illustrated, the coil 3511 for wireless charging may form a first magnetic field that passes through the first substrate 3510 in a direction perpendicular to the first substrate 3510.

The coils 3521 and 3531 for wireless communications may include the first coil 3521, formed on one side of the coil 3511 for wireless charging, and the second coil 3531, formed on the other side of the coil 3511 for wireless charging.

The first coil 3521 and the second coil 3531 may be wound around a second axis, provided in a direction disposed perpendicular to the first axis. That is, the first coil 3521 and the second coil 3531 may have a solenoid coil form wound around an axis parallel to the second substrate 3520 and the third substrate 3530.

The first coil 3521 and the second coil 3531 may form a second magnetic field, and at least some of a plurality of magnetic lines of force, representing the second magnetic field, may have a closed loop shape that passes through at least some regions of the first coil 3521 and at least some regions of the second coil 3531.

That is, a third magnetic field may be formed by a current flowing along the first coil 3521, a fourth magnetic field may be formed by a current flowing along the second coil 3531, and the second magnetic field may be formed by an interaction between the third magnetic field and the fourth magnetic field.

As illustrated, the above-mentioned second magnetic field may be a magnetic field that penetrates through the second substrate 3520 and the third substrate 3530 in order to circulate. Therefore, a magnetic field that covers the second substrate 3520 and the third substrate 3530 and is extended in a horizontal direction may be formed. As a result, for example, because the magnetic card reader 10 (FIG. 30) is able to smoothly perform the magnetic coupling even in any region of the second magnetic field, extended to be elongated, the magnetic card reader 10 is able to smoothly perform the magnetic coupling in various positions of the mobile terminal.

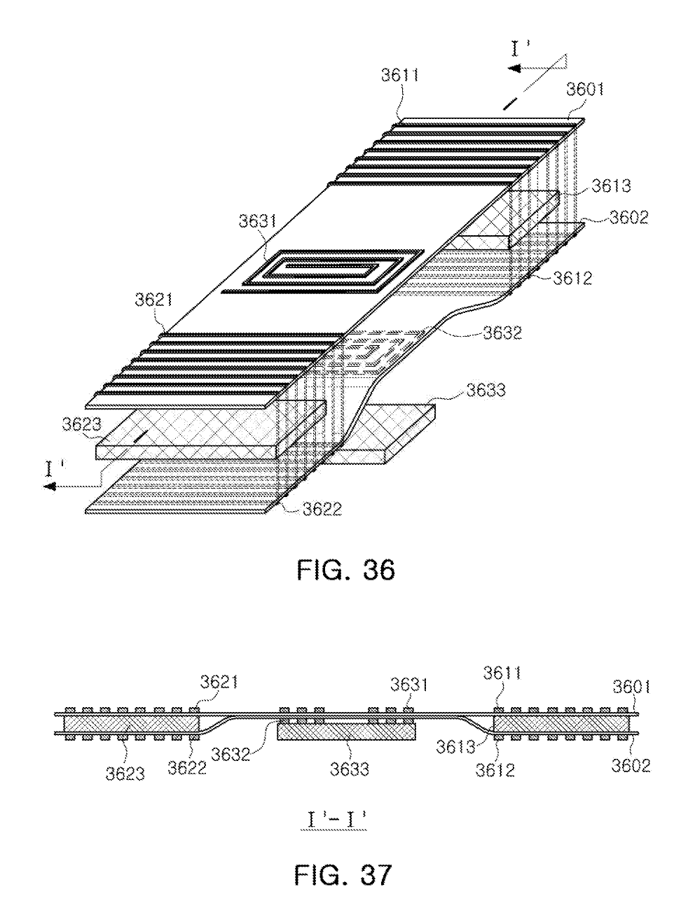

FIG. 36 is an exploded perspective view illustrating another example of a coil module formed using a multilayer substrate, and FIG. 37 is a cross-sectional view of the coil module illustrated in FIG. 36, taken along line I′-I′.

Referring to FIG. 36, the substrate may be a flexible substrate including multiple layers, and may include a first substrate 801 and a second substrate 3602.

The coil for wireless charging may include a first charging coil pattern 3631 formed on one surface of the first substrate 3601.

According to one or more embodiments, as in an illustrated example, the coil for wireless charging may also include the first charging coil pattern 3631, formed on one surface of the first substrate 3601, and a second charging coil pattern 3632, formed on the other surface of the second substrate 3602. Although not illustrated, the first charging coil pattern 3631 and the second charging coil pattern 3632 may be electrically connected to each other by a via hole.

The coil for wireless communications may include first communications coil patterns 3611 and 3612, formed on one side of the coil pattern 3631 for wireless charging, and second communications coil patterns 3621 and 3622, formed on the other side of the coil pattern 3631, for wireless charging.

It may be understood from the description of FIG. 35, above, that the first communications coil patterns 3611 and 3612, and the second communications coil patterns 3621 and 3622 may form a single magnetic field extended in a direction parallel to the substrate.

The first communications coil patterns 3611 and 3612 may include a first communications coil pattern 3611, formed on one surface of the first substrate 3601, a second communications coil pattern 3612, formed on the other surface of the second substrate 3602, and a plurality of via holes connecting the first communications coil pattern 3611 and the second communications coil pattern 3612 to each other.

Therefore, the first communications coil patterns 3611 and 3612, including the via holes, may be implemented in solenoid form including some regions of the substrate, and a first magnetic body 3613 may also be included in the solenoid form.

Similarly, the second coils may include a first communications coil pattern 3621 formed on one surface of the first substrate 3601, a second communications coil pattern 3622 formed on the other surface of the second substrate 3602, and a plurality of via holes connecting the first communications coil pattern 3621 and the second communications coil pattern 3622 to each other. The second coils may also be implemented in the solenoid form including some regions of the substrate, and a second magnetic body 3623 may be included in the solenoid form.

The coils 3631 and 3632 for wireless charging may include a third magnetic body 3633 below the substrate.

Referring to FIG. 37, because the substrates 3601 and 3602 may be formed as the flexible substrate, the first magnetic body 3613 is included in the substrate in a region of the substrate on which the first communications coil patterns 3611 and 3612 of the coil for wireless communications are formed, such that the first communications coil patterns 3611 and 3612 may be formed as the solenoid, and the second magnetic body 3623 is included in the substrate in the other region of the substrate on which the second communications coil patterns 3621 and 3622 of the coil for wireless communications are formed, such that the second communications coil patterns 3621 and 3622 may be formed as the solenoid.

Because a third magnetic body 3633 is formed to be adjacent to the other surface of the second substrate 3602, the coil patterns 3631 and 3632 for wireless charging may be formed on only one side of the third magnetic body 3633.

As described above, the coil for wireless charging and coil for wireless communications may be wound around different axes to form magnetic fields which are moved in different directions, respectively.

As set forth above, according to one or more embodiments, the coil for wireless communications is configured to secure reliability of the data transmission (even though the position or the angle of the receiving coil is changed and even though the mobile terminal may have a metallic housing), and the mobile terminal using the same, may be provided.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

As set forth above, according to the exemplary embodiments of the present disclosure, the coil module may improve communications performance while efficiently mounting various kinds of coils in the predetermined space.

According to the embodiments, because one widely spread magnetic field is formed using the two coils, a degree of magnetic coupling for communications may be improved.

While exemplary embodiments have been shown and described above, it will be apparent to those skilled in the art that modifications and variations could be made without departing from the scope of the present invention, as defined by the appended claims.

What is claimed is:

1. A composite wireless transmitter coil, comprising:
a first coil; and
a second coil spaced apart from the first coil,
wherein the first coil and the second coil form a first magnetic field, and
a magnetic line of force of the first magnetic field has a closed loop shape that passes through a region of the first coil and a region of the second coil.

2. The composite coil of claim 1, further comprising a metal part formed to be spaced apart from the first coil and the second coil between the first coil and the second coil, on a plane which is substantially the same as or is substantially parallel to the first coil or the second coil.

3. The composite coil of claim 1, further comprising a metal part overlapping the region of the first coil or the region of the second coil, on a plane which is substantially the same as or is substantially parallel to the first coil or the second coil.

4. The composite coil of claim 3, wherein the metal part comprises a metal plate comprising a slit or a through hole, and
the slit or the through hole overlaps the region of the first coil or the region of the second coil.

5. The composite coil of claim 1, wherein the first coil and the second coil are on a plane which is substantially the same or substantially parallel to each other, and
a second magnetic field, formed by the first coil, and a third magnetic field, formed by the second coil, are reinforced by each other in a first direction directed from the first coil to the second coil, or a second direction directed from the second coil to the first coil.

6. The composite coil of claim 1, wherein the first coil is wound in a clockwise direction,
the second coil is wound in a counterclockwise direction, and
the first coil and the second coil are configured to have a current flowing in the first coil and a current flowing in the second coil flowing in the clockwise direction.

7. The composite coil of claim 1, wherein the first coil and the second coil are wound in a clockwise direction,
the first coil is configured to have a current flowing in the clockwise direction, and
the second coil is configured to have a current flowing in a counterclockwise direction.

8. A mobile terminal comprising:
a housing;
a first coil disposed proximate to a first portion of the housing; and
a second coil spaced apart from the first coil in a length direction of the housing and disposed proximate to a second portion of the housing.

9. The mobile terminal of claim 8, wherein the housing comprises:
a non-metal part wherein at least some regions of the first coil and at least some regions of the second coil overlap the non-metal part, and
a metal part overlapping a second region of the first coil different from the first region or a second region of the second coil different from the first region, on a plane which is substantially the same as or substantially parallel to the first coil or the second coil.

10. The mobile terminal of claim 9, wherein the metal part comprises a slit or a through hole, and
a shape of the non-metal part corresponds to a shape of the slit or the through hole.

11. A coil module comprising:
a substrate;
a coil for wireless communications formed on one region of the substrate, and for performing communications with a first device wirelessly, using a first magnetic field; and
a coil for wireless charging formed on the other region of the substrate, and for receiving power from a second device wirelessly,
wherein the coil for wireless communications is wound around a first axis, and
the coil for wireless charging is wound around a second axis, disposed perpendicular to the first axis.

12. The coil module of claim 11, wherein the first axis is a direction parallel to the substrate, and
the second axis is a direction perpendicular to the substrate.

13. The coil module of claim 11, wherein the substrate includes a first magnetic body in one region of the substrate, and
the coil for wireless communications is a solenoid coil wound around the first magnetic body,
wherein the coil for wireless charging is formed on one surface of the other region of the substrate, and a second magnetic body is formed on the other surface of the other region of the substrate.

14. The coil module of claim 11, wherein the coil for wireless communications includes:
a first coil formed on one side of the coil for wireless charging; and
a second coil formed on the other side of the coil for wireless charging, and
the first coil and the second coil form the first magnetic field, and
a magnetic line of force of the first magnetic field has a closed loop shape that passes through a region of the first coil and a region of the second coil.

15. The coil module of claim 14, wherein the first coil and the second coil are solenoid coils wound in the same direction as each other, and
a direction of a current flowing in the first coil and a direction of a current flowing in the second coil are the same as each other.

16. The coil module of claim 14, wherein the first coil and the second coil are solenoid coils wound in directions opposing each other, and
a direction of a current flowing in the first coil and a direction of a current flowing in the second coil are the same as each other.

17. The coil module of claim 11, wherein the coil for wireless communications includes:
a first communications coil pattern formed on one surface of the substrate;
a second communications coil pattern formed on the other surface of the substrate; and
a plurality of via holes connected to the first communications coil pattern and the second communications coil pattern, and
the substrate includes a first magnetic body included in an inner region formed by the first communications coil pattern, the second communications coil pattern, and the plurality of via holes.

18. A mobile terminal receiving power wirelessly, or transmitting or receiving communications data wirelessly, using a coil module, the mobile terminal comprising:
a coil module including a substrate, and a coil for wireless communications and a coil for wireless charging formed on the substrate;
a wireless communications unit for performing communications with a first device wirelessly, through the coil for wireless communications; and
a wireless charging unit for receiving power from a second device wirelessly through the coil for wireless charging,
wherein the coil for wireless communications is wound around a first axis, and the coil for wireless charging is wound around a second axis, disposed perpendicular to the first axis.

19. The mobile terminal of claim 18, wherein the coil for wireless communications includes:
a first communications coil formed on one side of the coil for wireless charging; and
a second communications coil formed on the other side of the coil for wireless charging, and
the first communications coil and the second communications coil form a first magnetic field, and
a magnetic line of force of the first magnetic field has a closed loop shape that passes through a region of the first communications coil and a region of the second communications coil.

20. The mobile terminal of claim 18, wherein the coil for wireless communications includes:
a first communications coil pattern formed on one surface of the substrate;
a second communications coil pattern formed on the other surface of the substrate; and
a plurality of via holes connected to the first communications coil pattern and the second communications coil pattern, and
the substrate includes a first magnetic body included in an inner region formed by the first communications coil pattern, the second communications coil pattern, and the plurality of via holes.
